(19) United States
(12) Patent Application Publication
(10) Pub. No.: US 2017/0259343 A1
(43) Pub. Date: Sep. 14, 2017

(54) Bar Feeding Device

(71) Applicant: Index-Werke GmbH & Co. KG Hahn & Tessky, Esslingen (DE)

(72) Inventor: Karl-Heinz Schumacher, Reutlingen (DE)

(21) Appl. No.: 15/605,467

(22) Filed: May 25, 2017

Related U.S. Application Data
(63) Continuation of application No. PCT/EP2015/078493, filed on Dec. 3, 2015.

(30) Foreign Application Priority Data
Dec. 5, 2014 (DE) 10 2014 117 947.1

(51) Int. Cl. B23B 13/10; B23B 13/04; B23B 13/12; B23B 5/16

(52) U.S. Cl. CPC B23B 13/10; B23B 5/16; B23B 13/04; B23B 13/12

(57) ABSTRACT

In order for a bar feeding device comprising at least one bar guide for feeding at least one item of bar stock to at least one workpiece spindle of a lathe, and a machining unit, for producing an end contour at one end of the item of bar stock, which enables gripping of the end by means of a collet chuck in the bar guide to be improved such that said bar feeding device operates as efficiently as possible and in particular reloading of items of bar stock into the at least one bar guide can be performed as efficiently as possible and within a short time, it is proposed that the bar feeding device has a bar loading magazine that is rotatable about a magazine axis and comprises more than two bar guides that are disposed about the magazine axis in a magazine drum, and that the bar feeding device comprises a buffer storage unit that is disposed between the machining unit and the bar loading magazine and stores a plurality of premachined items of bar stock that are provided with the end contour.

### CROSS-REFERENCE TO RELATED PATENT APPLICATION

This application is a continuation of International application number PCT/EP2015/078493 filed on Dec. 3, 2015.

This patent application claims the benefit of International application No. PCT/EP2015/078493 of Dec. 3, 2015 and German application No. 10 2014 117 947.1 of Dec. 5, 2014, the teachings and disclosure of which are hereby incorporated in their entirety by reference thereto.

### BACKGROUND OF THE INVENTION

The invention relates to a bar feeding device comprising at least one bar guide for feeding at least one item of bar stock to at least one workpiece spindle of a lathe, and a machining unit for producing an end contour at one end of the item of bar stock, which enables gripping of the end by means of a collet chuck of the bar guide.

Bar feeding devices of this type are known from EP 1 108 488 B1; in the case of said bar feeding devices there is the problem, in particular when a plurality of bar guides are provided, that the reloading of items of bar stock into the bar guides results in prolonged downtime in the case of the lathe that is provided with the bar feeding device.

The invention is therefore based on the object of improving a bar feeding device in such a manner that the latter operates as efficiently as possible and in particular reloading of items of bar stock into the at or least one bar guide can be performed as efficiently as possible and within a short time.

### SUMMARY OF THE INVENTION

This object in the case of a bar feeding machine of the type mentioned at the outset is achieved according to the invention in that the bar feeding device has a bar loading magazine that is rotatable about a magazine axis and comprises more than two bar guides that are disposed about the magazine axis in a magazine drum, and in that the bar feeding device comprises a buffer storage unit that is disposed between the machining unit and the bar loading magazine and stores a plurality of premachined items of bar stock that are provided with the end contour.

The advantage of the solution according to the invention is to be seen in that by providing the buffer storage unit there is the possibility for items of bar stock that have already been premachined to be provided for reloading, and for the latter to then be rapidly loaded from the buffer storage unit into the individual bar guides of the bar loading magazine, without temporal limitations pertaining to premachining of said items of bar stock by the machining unit being created.

In particular, the time periods required for premachining the items of bar stock in the machining unit thus are no longer significant when loading the bar guides with items of bar stock.

Up to this point, no further details have been specified in terms of the configuration, in particular the size, of the buffer storage unit in this context.

One advantageous solution thus provides that the plurality of the premachined items of bar stock that are stored in the buffer storage unit correspond to at least the number of bar guides in the bar loading magazine, reduced by one item of bar stock.

It is even more advantageous if the number of the items of bar stock that are stored in the buffer storage unit corresponds to the number of bar guides in the bar loading magazine, such that when loading of the bar guides in the bar loading magazine is performed, all of the items of bar stock are already available and in the bar feeding device thus can be rapidly inserted from the buffer storage unit into the bar guides.

In terms of an arrangement that is as advantageously space-saving as possible it is preferably provided that the buffer storage unit is disposed in the vertical direction above the bar loading magazine, such that the space requirement of the bar feeding device can be reduced.

It is furthermore preferably provided that the buffer storage unit has a storage element that carries the items of bar stock and in particular transfers the items of bar stock from a receiving position of the buffer storage unit to a discharging position of the buffer storage unit.

A movement of the items of bar stock in the direction of the discharging position is thus at all times generated by the storage element itself in the buffer storage unit, the items of bar stock then being able to be acquired from said discharging position in order for said items of bar stock to be inserted into the bar guides.

It is particularly favorable herein for the buffer storage unit to have a conveyor unit that moves the items of bar stock, said conveyor unit thus ensuring at all times that at least one of the items of bar stock is available in the discharging position, in order for said item of bar stock to then be inserted into the bar loading magazine.

In order for the insertion of the items of bar stock from the buffer storage unit to be able to be performed as efficiently as possible, it is preferably provided that the buffer storage unit is adjoined by a loading unit which inserts the items of bar stock from the buffer storage unit into a receptacle of that bar guide that is in an insertion position.

This means that the plurality of the bar guides of the bar loading magazine are moved such that that bar guide that is provided for inserting the item of bar stock is in the insertion position, insertion of the item of bar stock that has been removed from the discharging position of the buffer storage unit in the respective bar guide then being performed in this insertion position.

In principle, the loading unit could operate in the most varied ways.

One advantageous solution herein provides that the loading unit acquires the item of bar stock in the discharging position of the buffer storage unit and transports said item of bar stock to the receptacle of the respective bar guide that is in the insertion position.

The loading unit herein could theoretically be a robot which acquires the item of bar stock from the discharging position of the buffer storage unit and inserts said item of bar stock into the receptacle of that bar guide that is in the insertion position.

One particularly cost-effective loading unit that operates efficiently provides that said loading unit, by means of a lift conveyor, lowers the items of bar stock leaving the buffer storage unit such that moving of the items of bar stock by the lift conveyor can be performed in a defined manner.

In particular, it is preferably provided that the items of bar stock can be removed in a particularly simple manner from the buffer storage unit, for example by lifting therefrom, by way of the lift conveyor.

It is furthermore preferably provided that the lift conveyor transfers the item of bar stock to an insertion device which introduces the item of bar stock into the receptacle of that bar guide that is in the insertion position.

An insertion device of this type could also operate by way of a movable gripper, for example.

One particularly preferable and cost-effective solution provides that the insertion device has an insertion ramp on which the item of bar stock, driven by gravity, moves into the receptacle.

In order for there to be a sufficiently large number of blank items of bar stock available for machining by the machining unit, it is preferably provided that a bar stock loading unit which stores blank items of bar stock and feeds the latter to the machining unit is disposed upstream in the machining unit.

A bar stock loading unit of this type herein can be configured in the most varied ways.

For example, it would be conceivable for the bar stock loading unit to be configured as a planar loading unit or as a bundle loading unit.

In order to be able to manufacture the bar feeding device according to the invention in as flexible a manner as possible for the respective customer requirements, one advantageous solution, alternatively or additionally to the solution as described so far, provides that the at least one bar guide and the machining unit form components of a basic unit which is combinable selectively with a bundle loading unit or a planar loading unit for storing and feeding items of bar stock to the basic unit.

The advantage of this solution is to be seen in that the basic unit remains the same at all times, and thus can be combined either with a bundle loading unit or with a planar loading unit, depending on the requirements of the customer, without constructive modification of the basic unit being required.

In the case of a basic unit being provided, there is the further possibility for the bar stock loading unit to be interchanged, that is to say for a bundle loading unit to be replaced by a planar loading unit, or for a planar loading unit to be replaced by a bundle loading unit.

In the case of a solution of this type it is particularly advantageous if the bundle loading unit and the planar loading unit each have one conveyor installation which conveys the item of bar stock to the machining unit.

One advantageous solution herein provides that the conveyor installation comprises a transverse conveyor unit which conveys the items of bar stock to the machining unit.

The transverse conveyor unit herein can interact directly with the storage unit for the blank items of bar stock, or optionally a further conveyor unit which moves the items of bar stock to the transverse conveyor unit can be provided in addition to the transverse conveyor unit.

Likewise, no further details in terms of the configuration of a planar loading unit of this type have been specified to this point.

One advantageous solution thus provides that the planar loading unit has a planar storage unit having a loading platform on which the items of bar stock are stored.

It is furthermore advantageously provided that the planar loading unit transfers the items of bar stock in a bar transfer arrangement to a conveyor unit which in turn transfers the items of bar stock to the transverse conveyor unit.

No further details in terms of the configuration of the bundle loading unit have been specified in conjunction with the previous solution.

One advantageous solution thus provides that the bundle loading unit has a bundle cradle.

It is preferably provided herein that the bundle cradle is associated with a bundle lifting system which lifts the bundle of items of bar stock in the bundle cradle and feeds individual items of bar stock to the conveyor installation, in particular to the transverse conveyor installation.

Lifting of the bundle is preferably performed such that the items of bar stock are fed to the machining unit individually and sequentially.

The most varied possibilities are conceivable in terms of the bundle lifting system; the bundle lifting system could have a support on which the bundle rests, for example.

One advantageous solution provides that the bundle lifting system comprises lifting belts which receive the bundle by way of lifting belt slings that sag in the direction of gravity, and lift said bundle by reducing the size of the lifting belt slings.

Alternatively or additionally to the solutions described up to this point, one further advantageous solution which in particular is also independent of the solutions explained above, provides that the bar feeding device comprises a bar loading magazine that is rotatable about a magazine axis and has at least two bar guides that are disposed about the magazine axis on a magazine drum.

A bar loading magazine of this type has the great advantage that by way of said bar loading magazine a spindle drum of a multi-spindle machine tool can be provided with items of bar stock in a simple manner, wherein each workpiece spindle of the machine tool is preferably associated with one bar guide such that each workpiece spindle of the machine tool interacts at all times with a bar guide and is provided with an item of bar stock by said bar guide.

Likewise, no further details in terms of the alignment of the guide axis of the bar guides relative to the magazine axis have been specified to this point.

A particularly expedient solution provides that the guide axis of each of the bar guides runs parallel with the magazine axis such that the items of bar stock can be transferred in a simple manner from the bar guides to the respectively associated workpiece spindles of a spindle drum of a multi-spindle lathe.

In order for the bar feeding device according to the invention to be able to be constructed in as compact a manner as possible and for the typically very long items of bar stock to be able to be handled in as an efficient and space-saving manner as possible in the bar feeding device, it is preferably provided that the items of bar stock in the bar stock loading unit are aligned so as to be parallel with the guide axes of the bar guides.

It is furthermore preferably provided that the blank items of bar stock in the machining unit are aligned so as to be parallel with the guide axis of the bar guides.

Also in connection with the buffer storage unit that is provided according to the invention, it is advantageous in particular for the spatial extent of the buffer storage unit if the premachined items of bar stock in the buffer storage unit are aligned so as to be parallel with the guide axis of the bar guides.

It is furthermore likewise advantageously provided that the premachined items of bar stock are moved by the loading unit in an alignment that is parallel with the guide axes of the bar guides.

One particularly favorable solution provides that the items of bar stock on their way from the bar stock loading unit up to inside the bar guides are aligned so as to be parallel with the guide axis.

In order to be able to move the items of bar stock in the bar guides in the direction of the lathe it is preferably provided that each of the bar guides is associated with a dedicated advancing unit for moving the respective items of bar stock in the direction of the guide axes such that on account thereof the respective item of bar stock is at all times positionable in the respective bar guide by the same advancing unit, and advancing of the item of bar stock can also be performed during a rotation of the magazine drum, for example.

No further details in terms of the configuration of the advancing unit in conjunction with the previous solution have been specified up to this point.

Theoretically, the advancing unit could be configured as is known from the prior art, for example, such that said advancing unit in each case advances the item of bar stock so far until the latter runs through a detent which is disposed in the lathe, for example, and the position of the item of bar stock is thus defined by the detent.

It is particularly advantageous, however, if the advancing unit is electronically controlled and positions the item of bar stock in a controlled manner in the direction of the guide axis such that the item of bar stock is thus already positionable by way of the advancing unit, and a detent for establishing the position of the item of bar stock in the lathe is no longer required.

It is particularly favorable for the advancing unit to be configured such that the item of bar stock by way of said advancing unit is positioned in a positionally correct manner by virtue of the electronic controlling of the advancing unit.

One particularly advantageous solution provides that the advancing units of the bar guides are actuated in a mutually independent manner such that advancing of the item of bar stock in each of the individual bar guides can be performed independently from the other bar guides.

For example, the advancing unit is configured such that the latter comprises an advancing element that engages in the respective guide channel of the bar guide.

In principle, the advancing unit can be configured in the most varied of ways.

For example, it would be conceivable for the advancing unit to be configured as a hydraulic advancing unit or as a mechanical advancing unit having a spindle drive.

One particularly expedient solution provides that the advancing unit comprises a drive belt which extends along the bar guide and supports the advancing finger.

The drive belt herein is preferably disposed such that said drive belt has a run that faces the bar guide and to which the advancing finger is connected such that the advancing finger is movable by the drive belt along substantially the entire bar guide.

The drive belt herein could be drivable by a hydraulic drive, for example.

One particularly expedient solution provides that the drive belt is drivable by an electric motor.

An electric motor of this type is likewise electronically controllable in a simple manner in order for the advancing finger to be able to be already precisely positioned by virtue of the control.

In this case, the electric drive is provided with a position encoder, for example.

By way of a position encoder of this type it is in particular possible herein for the advancing finger and thus also the item of bar stock that is acted upon directly or indirectly by said advancing finger to be positioned in a positionally accurate manner in the direction of the guide axis.

An item of bar stock that is inserted into the bar guide is preferably displaceable in the direction of the guide axis by way of the advancing element.

In the context of the description of various solutions up to this point, no further details have been specified in terms of the configuration of the bar guides.

Alternatively or additionally to the solutions described up to this point, one further advantageous solution of the object mentioned at the outset, which in particular is also independent of the solutions explained above, provides that each of the bar guides has at least one guide housing in which a guide channel for the item of bar stock runs.

By way of a configuration of the guide housing of this type, the possibility of dimensioning the guide channel such that the item of bar stock when being machined on a lathe can be guided in a reliable and secure manner is advantageously achieved.

It is provided in particular for the item of bar stock in the guide channel by way of insertion elements that form the guide channel to be optionally guided precisely and accurately also by way of an oil bath, so as to prevent movements transverse to the guide axis and losses in quality that are associated with said transverse movements when machining on a lathe.

The guide housing having the guide channel herein can be configured in the most varied of ways.

One advantageous solution thus provides that the guide housing has two guide housing shells which for incorporating the item of bar stock into the guide channel are configured to be moved apart from each other and towards each other transversely to the guide axis of the guide channel.

This means that by way of the guide housing shells there is the possibility for the guide channel to be opened and for the item of bar stock to be inserted into the guide channel transversely to the channel axis.

Both guide housing shells herein can be movable relative to one another, for example.

One particularly expedient solution provides that a second of the guide housing shells is configured to be movable apart from and towards the first of the guide housing shells, that is to say that the first of the guide housing shells is fixedly connected to the magazine drum and thus remains stationary in the insertion position, and the second of the guide housing shells is movable relative to the first guide housing shell that remains stationary in the insertion position, in order for access to the guide channel that is performed transversely to the guide axis to be achieved.

Herein, the second of the guide housing shells could be movable relative to the first of the guide housing shells in the most varied of ways and by way of the most varied of motion kinematics.

One particularly expedient solution provides that the second of the guide housing shells is pivotable relative to the first of the guide housing shells, since this solution in terms of construction is implementable in a very simple and expedient manner.

In order for the item of bar stock to be able to be utilized in as optimal a manner as possible, in particular with a view to the length of the workpiece spindle of a lathe, it is preferably provided that a supply bar is insertable into a guide channel of the at least one bar guide.

In order for a useful interaction to be able to take place with said supply bar, it is provided that the supply bar is coupleable to the advancing element.

In order for the bar guide not to have to be configured so long when a supply bar is used that said bar guide by way of the maximum length thereof can receive the supply bar and the item of bar stock, it is provided for the supply bar to be removed from the guide channel in order for the item of bar stock to be able to be inserted, and for the supply bar to then be inserted into the guide channel again once the item of bar stock has been advanced.

One particularly favorable solution provides that the supply bar is held in an initial position in the movable guide housing shell, and said supply bar when said guide housing shell is moved from the closed position to the opened position is movable conjointly with said guide housing shell, such that the supply bar is not obstructive when the item of bar stock is inserted in a direction transverse to the guide axis, and the item of bar stock can be inserted into the receptacle of the non-movable guide housing shell such that said item of bar stock extends in a region in which the supply bar lies in the receptacle of the movable guide housing shell.

It is in particular provided herein that in the case of the second guide housing shell being in the opened position, the item of bar stock, in an insertion position that in the direction of the guide axis overlaps with the supply bar, is insertable into the receptacle of the first guide housing shell.

On account of the item of bar stock being held in the second guide housing shell and being moved by the latter out of the receptacle of the first guide housing shell, there is thus the possibility for the item of bar stock that is intended to be inserted into the first guide housing shell in an insertion position in which said item of bar stock in relation to the direction of the guide axis overlaps with the position of the supply bar in the second guide housing shell.

There is preferably the possibility for the item of bar stock that lies in the insertion position in the receptacle of the first guide housing shell to be advanced by way of the advancing element in the direction of the lathe such that, on account thereof, the item of bar stock can already be introduced into the workpiece spindle of the lathe despite the movable second guide housing shell still being in the opened position.

For example, upon a return movement of the guide element to the initial position, in the case of an advancing element that is in an initial position and in the case of an item of bar stock that is advanced in the direction of the lathe, there is the possibility for the supply bar to be inserted between the advancing element and the item of bar stock.

In principle, it would be conceivable for the supply bar to be inserted from an external parking position.

However, it is particularly advantageous if the supply bar by moving the second guide housing shell from the opened position to the closed position is insertable between the advancing element and the advanced item of bar stock.

It is furthermore provided preferably for coupling the supply bar to the advancing element that the supply bar when being inserted between the advancing element and the advanced item of bar stock is coupleable to the advancing element.

The supply bar herein is preferably connectable to the advancing element in positively-locking manner.

In order for a fixed connection to be able to be likewise implemented between the supply bar and the item of bar stock it is preferably provided that the supply bar is provided with a collet chuck.

A collet chuck of this type can be configured in the most varied of ways.

One solution would be for the collet chuck to grip the item of bar stock in a circumferential manner, this however being an impediment when the item of bar stock is advanced while simultaneously being guided.

For this reason, it is preferably provided that the collet chuck is an internal collet chuck which engages through a bore in the end contour of the premachined item of bar stock and, on account thereof, is capable of holding the item of bar stock such that the latter is movable in the advancing direction toward the lathe but can also be retracted again from the lathe counter to the advancing direction.

This solution in particular achieves the possibility for a leftover piece of the item of bar stock that has not been fully processed in the lathe to be moved out of the lathe again and into the bar guide, and for said leftover piece in the region of the bar guide then to be removed and disposed of.

In terms of the configuration of the bar guides themselves no further details have been specified in the context of the explanations of the individual exemplary embodiments up to this point.

It would be conceivable, for example, for the bar guides to be configured as continuous elements, in particular having a guide housing that runs across the entire length of said elements, having guide housing shells that likewise run across the entire length.

However, one particularly advantageous solution provides that the respective bar guide comprises two guide segments that are sequentially disposed in the direction of the guide axis, an intermediate removal space being disposed between said guide elements.

Providing an intermediate removal space of this type achieves the possibility for a leftover piece to be advantageously removed after full processing of the item of bar stock.

The guide segments herein are configured such that, in particular each of the guide segments comprises two guide housing shells which are movable relative to one another and are movable from a closed position, forming the guide housing, to an opened position, in order for the item of bar stock to be inserted into one of the guide housing shells by a movement transverse to the guide axis.

The invention moreover relates to a method for operating a bar feeding device comprising at least one bar guide for feeding at least one item of bar stock to at least one workpiece spindle of a lathe, and a machining unit by way of which an end contour on each item of bar stock is produced by machining one end, wherein according to the invention the items of bar stock that are provided with the end contour are stored in a buffer storage unit and are sequentially loaded from the buffer storage unit into a plurality of bar guides.

The advantage of this solution is to be seen in that by providing a buffer storage unit there is the possibility in the case of a plurality of guide bars for the latter to be sequentially loaded in a very short time, since premachining of the items of bar stock by the machining unit can be performed independently from loading of the bar guides.

In particular when all guide bars have been loaded with a new item of bar stock, the buffer storage unit can be refilled in the time in which processing of all items of bar stock in all bar guides is performed.

Loading of the bar guides is preferably performed in that the bar guides are sequentially moved to an insertion position in which loading thereof with one of the items of bar stock from the buffer storage unit is performed.

It is preferably provided herein that the bar guides for loading the items of bar stock are individually and sequentially moved to the same insertion position and loaded with items of bar stock.

Rapid loading of the bar guides is advantageously implementable in particular when the bar guides are provided in a magazine drum such that the bar guides are sequentially moved to the insertion position by rotating the magazine drum and in the latter can be loaded with one of the items of bar stock from the buffer storage unit.

In terms of the processing of the blank items of bar stock, no further details have likewise been specified in the context of the method according to the invention.

It is thus advantageously provided that blank items of bar stock are fed to the machining unit, machined by the latter and then transferred to the buffer storage unit.

In terms of the procedures during loading of the bar guides, no further details have been specified in particular in the context of the method according to the invention.

It is thus advantageously provided that the bar guides have a guide housing of guide housing shells, said guide housing for in each case inserting one of the items of bar stock from the buffer storage unit being opened by moving apart the guide housing shells.

In the case of the method according to the invention, loading of the bar guides with items of bar stock is preferably performed in such a manner that the respective item of bar stock is inserted into this transversely to a guide axis of the bar guides.

In order for the item of bar stock to be advanced it is preferably provided that the item of bar stock that in the insertion position is inserted into one of the guide housing shells is advanced in the direction of the lathe by way of an advancing element.

In terms of construction, this can be preferably implemented in a particularly simple manner if in the case of an advancing element that is in the initial position, the item of bar stock in the insertion position thereof is arranged in the advancing ahead of the advancing element such that the advancing element can then push forward the item of bar stock lying in front of said advancing element.

In order to have as few leftover pieces of the items of bar stock as possible after processing of the latter, the use of a supply bar is preferably provided in the case of the method according to the invention.

The use of a supply bar requires a sufficiently long bar guide, for example such that the item of bar stock is at all times inserted into the guide bar ahead of the supply bar.

In the case of as short a bar guide as possible being used, subsequent insertion of the supply bar is preferably only possible once the item of bar stock has been advanced by a distance which corresponds to at least the length of the supply bar.

To this end it is preferably provided that the supply bar, in the case of an advancing element that is in an initial position, is inserted in an insertion position into one of the guide housing shells in the advancing direction ahead of the advancing element.

It is particularly favorable herein if upon the item of bar stock having been advanced by the advancing element, the advancing element is moved back to the initial position thereof, and the supply bar is then inserted between the advancing element and the advanced item of bar stock, wherein advancing of the item of bar stock by the advancing element is performed by a path length which corresponds to at least the length of the supply bar.

In principle, the supply bar during loading of the item of bar stock could be deposited outside the bar guide, and in turn be subsequently introduced or inserted into the bar guide.

A particularly favorable solution provides that the supply bar in the initial position thereof is held in one of the guide housing shells, and that the item of bar stock when being inserted is inserted into a receptacle of the other of the guide housing shells.

This means that by the moving apart of the guide shells and by holding the supply bar in one of the guide housing shells, the possibility for the supply bar to be removed from the receptacle of the other of the guide housing shells and for this receptacle to thus be available for receiving the new item of bar stock to be introduced is already opened up.

It is expediently provided in this case that the item of bar stock that is inserted into the receptacle of the other guide housing shell in the case of moved apart guide housing shells is advanced in the direction of the lathe, that is to say that no closing of the guide housing shells is performed at all before the inserted item of bar stock has been advanced from the insertion position by a path which corresponds to at least the length of the supply bar.

It is thus expediently possible in this case for the supply bar to be inserted between the advancing element and the advanced item of bar stock by closing the guide housing shells, such that no additional handling whatsoever is required for moving the supply bar into the guide housing.

It is provided in this case in particular that the supply bar is coupled to the advancing element by closing the guide housing shells, for example in that positively-locking elements between the advancing element and the supply bar come into engagement, and the supply bar can thus be moved by the advancing element both in the advancing direction as well as in the direction counter to the advancing direction.

It is furthermore preferably provided that the supply bar is coupled to the end contour of the item of bar stock such that a collet chuck of the supply bar comes into engagement with the end contour.

Such an engagement can be implemented in a particularly favorable manner if the supply bar is advanced by the advancing element so far that the collet chuck comes into engagement with the end contour.

After loading the item of bar stock into the bar guide, advancing said item of bar stock, and inserting the supply bar between the advancing element and the item of bar stock, there is thus the possibility of moving the entire assembly comprising the advancing element, the supply bar, and the item of bar stock, both in the advancing direction as well as in the direction counter to the advancing direction.

Further features and advantages of the invention are the subject matter of the description hereunder and of the illustration of a few exemplary embodiments by way of the drawing.

### BRIEF DESCRIPTION OF THE DRAWINGS

FIG. 1 shows a perspective illustration of a first exemplary embodiment of a bar feeding device according to the invention, in combination with a lathe (indicated by a dashed line);

FIG. 2 shows a perspective illustration similar to FIG. 1, having covers removed;

FIG. 3 shows a view in the direction of the arrow A in FIG. 2;

FIG. 4 shows a section along the line 4-4 in FIG. 2, however having only that bar guide that is in the insertion position, the other bar guides having been omitted for improved clarity;

FIG. 5 shows a view in the direction of the arrow B in FIG. 2;

FIG. 6 shows an enlarged section along the line 6-6 in FIG. 5;

FIG. 7 shows a section along the line 7-7 in FIG. 5;

FIG. 8 shows a section similar to FIG. 6, having an item of bar stock lifted to a processing position;

FIG. 9 shows an enlarged section along the line 9-9 in FIG. 5;

FIG. 10 shows a section along the line 10-10 in FIG. 5;

FIG. 11 shows a longitudinal section through an end of a premachined item of bar stock;

FIG. 12 shows a section similar to FIG. 6, following machining of an item of bar stock;

FIG. 13 shows a section similar to FIG. 6, having the illustration of the loading unit in various states when transporting a premachined item of bar stock from the buffer storage unit to a bar guide that is in the insertion position;

FIG. 14 shows a perspective illustration of the first exemplary embodiment of the bar feeding device according to the invention, having removed covers, and illustration with a view towards a loading unit for transporting an item of bar stock from the buffer storage unit to a bar guide of the bar loading magazine, however with the illustration of only one bar guide in the bar loading magazine, since the other bar guides have been omitted for reasons of clarity;

FIG. 15 shows a partial illustration of the loading unit according to the invention when loading a bar guide that is in an insertion position, wherein with the exception of the bar guide all other elements of the bar loading magazine have been omitted;

FIG. 16 shows an enlarged illustration of a guide segment of the bar guide of the magazine drum, said guide segment being disposed on a support body of the magazine drum so as to face the lathe;

FIG. 17 shows an illustration similar to FIG. 16 of a guide segment of the bar guide that faces away from the lathe, together with the support body of the magazine drum in the case of an opened second guide housing shell which in the opened position holds the supply bar, when a premachined item of bar stock is inserted into a receptacle of the guide housing shell that is in the insertion position and is fixedly connected to the drum body;

FIG. 18 shows an illustration similar to FIG. 17, having an item of bar stock that is inserted into the guide housing shell that is in the insertion position;

FIG. 19 shows a lateral view of an opened guide housing of the guide segment 212, having a movable housing shell 226 that has been moved away from the stationary guide housing shell 224 in the insertion position, and having a supply bar disposed in the movable housing shell;

FIG. 20 shows a perspective illustration of the opened guide housing according to FIG. 19;

FIG. 21 shows a partial, enlarged illustration, of a region C in FIG. 20;

FIG. 22 shows a partial, enlarged illustration, of a region D in FIG. 20;

FIG. 23 shows a lateral view of the supply bar;

FIG. 24 shows a section through the guide housing of the guide segment 212, fitted to the support body 228, and with illustration of the advancing unit 270;

FIG. 25 shows a view of a rear side of the magazine drum of the bar loading magazine, facing away from the lathe;

FIG. 26 shows a schematic illustration of a connection between the supply bar and the item of bar stock that is provided with the end contour;

FIG. 27 shows a view from the side onto an intermediate removal space between the guide segments of a bar guide;

FIG. 28 shows a perspective illustration of the end of the leftover piece of the item of bar stock and of a gripper for the removal of the leftover piece;

FIG. 29 shows a perspective illustration of a basic unit of the first exemplary embodiment of a bar feeding device according to the invention;

FIG. 30 shows a view of the basic unit in the direction of the arrow E in FIG. 29, with the lateral cladding removed;

FIG. 31 shows a perspective illustration of a planar loading unit for fitting to the basic unit;

FIG. 32 shows a section along the line 32-32 through the planar loading unit;

FIG. 33 shows a perspective illustration of a second exemplary embodiment of a bar feeding device having a basic unit and a bundle loading unit;

FIG. 34 shows a section along the line 34-34 in FIG. 33;

FIG. 35 shows a perspective illustration of a bundle loading unit for fitting to the basic unit;

FIG. 36 shows a section along the line 36-36 in FIG. 35; and

FIG. 37 shows a section similar to FIG. 36, with illustration of a bundle lifting system.

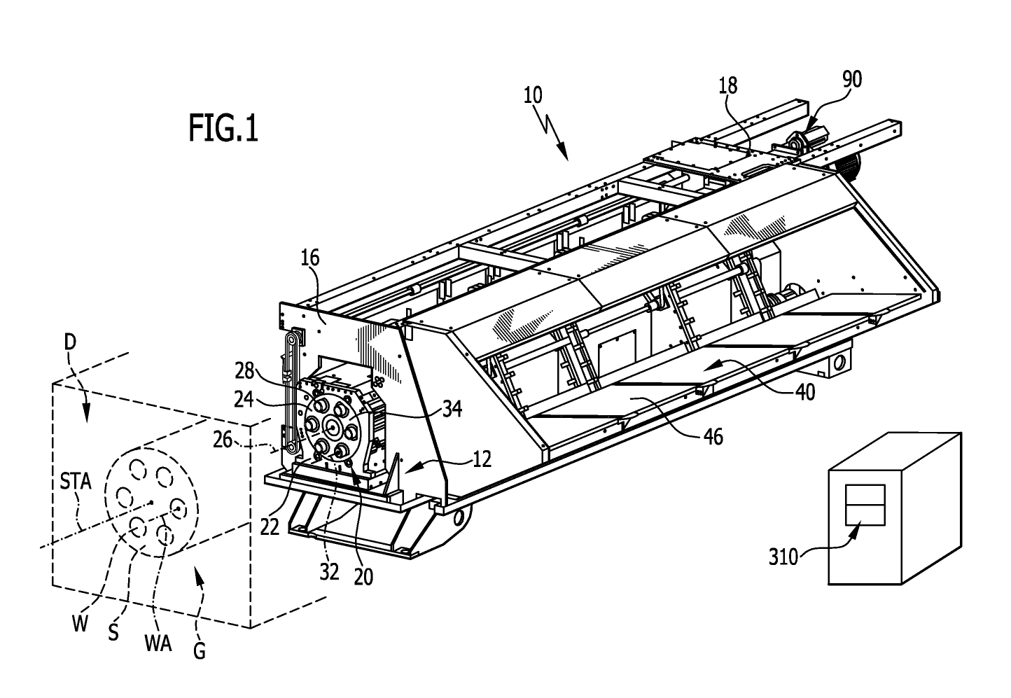

### DETAILED DESCRIPTION OF THE INVENTION

A bar feeding device, that in its entirety is identified by the reference sign 10, for feeding items of bar stock 14 to lathes, in particular for multi-spindle lathes D, comprises a frame identified by the reference sign 12, which has a front side 16 facing the respective lathe, and a rear side 18 facing away from the respective lathe. A bar loading magazine that in its entirety is identified by the reference sign 20 is disposed in the frame 12.

The bar loading magazine 20 comprises a magazine frame 22 in which a magazine drum 24 is disposed so as to be rotatable about a magazine axis 26.

The magazine drum 24 on its part has a plurality of bar guides 28 that are disposed about the magazine axis 26 and are preferably disposed at identical angular spacings about the magazine axis 26 and are movable about the magazine axis 26 by rotating the magazine drum 24.

The items of bar stock 14 are in each case guided in the guide bars 28 so as to be coaxial with a guide axis 32 and herein are rotatable about the guide axis 32 and displaceable in the direction of the guide axis 32, wherein the guide axis 32 runs parallel with the magazine axis 26.

For processing, the items of bar stock 14 can be pushed beyond a front end 34 of the magazine drum 24 that faces the lathe D and is disposed in the region of the front side 16 into a workpiece spindle of the lathe D.

The bar guides 28 herein are disposed in the magazine drum 24 in such a manner that guide axes 32 of the bar guides 28 can be disposed so as to be coaxial with workpiece spindle axes WA of workpiece spindles W, for example of a spindle drum S of the multi-spindle lathe D, such that there is the possibility for items of bar stock 14 to be simultaneously fed to all workpiece spindles W in a spindle drum S of a multi-spindle lathe by way of the bar guides 28 of the magazine drum 24, wherein the magazine drum 24 in this case rotates conjointly with the spindle drum S of the multi-spindle lathe D, wherein in this case the magazine axis 26 is disposed so as to be coaxial with the spindle drum axis STA of a spindle drum S of this type.

In the case of the bar magazine 20 according to the invention, the items of bar stock 14 herein are guided so as to be rotatable in the bar guides 28 such that the items of bar stock 14 when machined by turning by means of the respective workpiece spindle W rotate conjointly with the latter and are imparted guidance in a manner coaxial with the workpiece spindle axis WA by the respective bar guide 28.

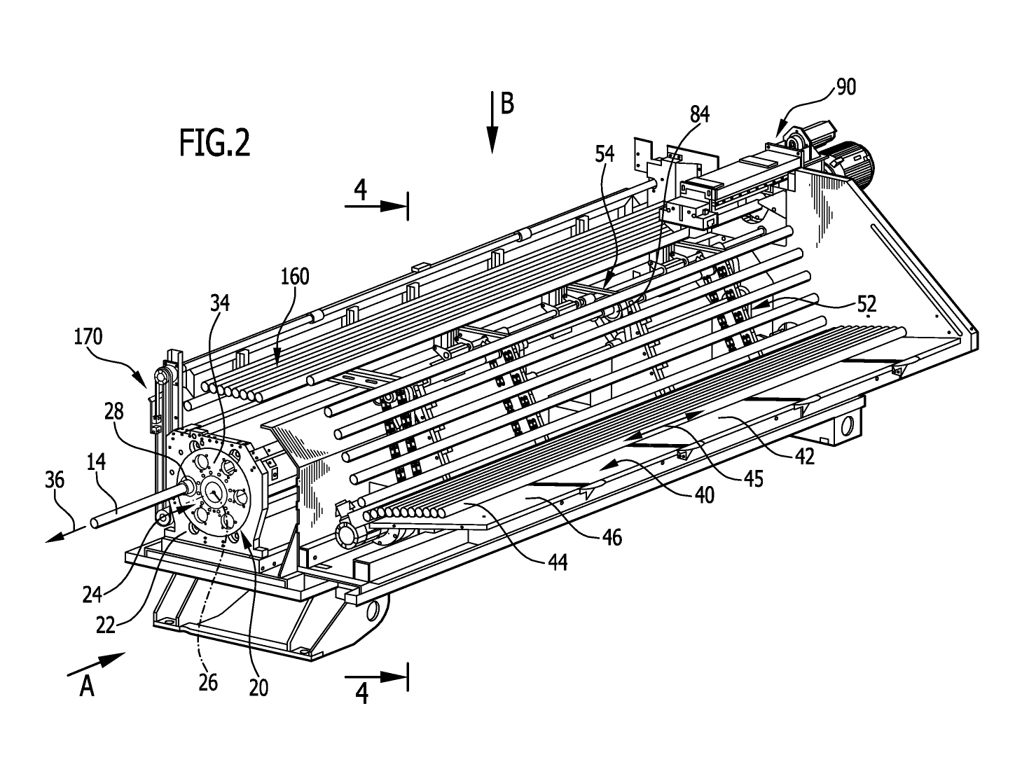

Furthermore, the items of bar stock 14 in the bar guides 28 are displaceable, in particular advanceable, in the direction of the guide axis 32, such that the items of bar stock 14 can be repeatedly fed in an advancing direction 36, so as to correspond to the processing of said items of bar stock in the respective workpiece spindle W, as is illustrated in FIG. 2 and is yet to be explained in detail hereunder.

The processing of the items of bar stock 14 makes it necessary for new items of bar stock 14 to be fed to the bar guides 28 in the magazine drum 24 once said items of bar stock 14 disposed within have been fully processed, so as to be able to continue the processing.

To this end, there is provided, in the case of the bar feeding device 10 according to the invention, a bar stock loading unit which in its entirety is identified by the reference sign 40 and which is configured as a planar loading unit for example and on a planar storage unit 42 receives blank items of bar stock 44 and stores them by way of the longitudinal axes 45 thereof being aligned so as to be parallel with the magazine axis 26.

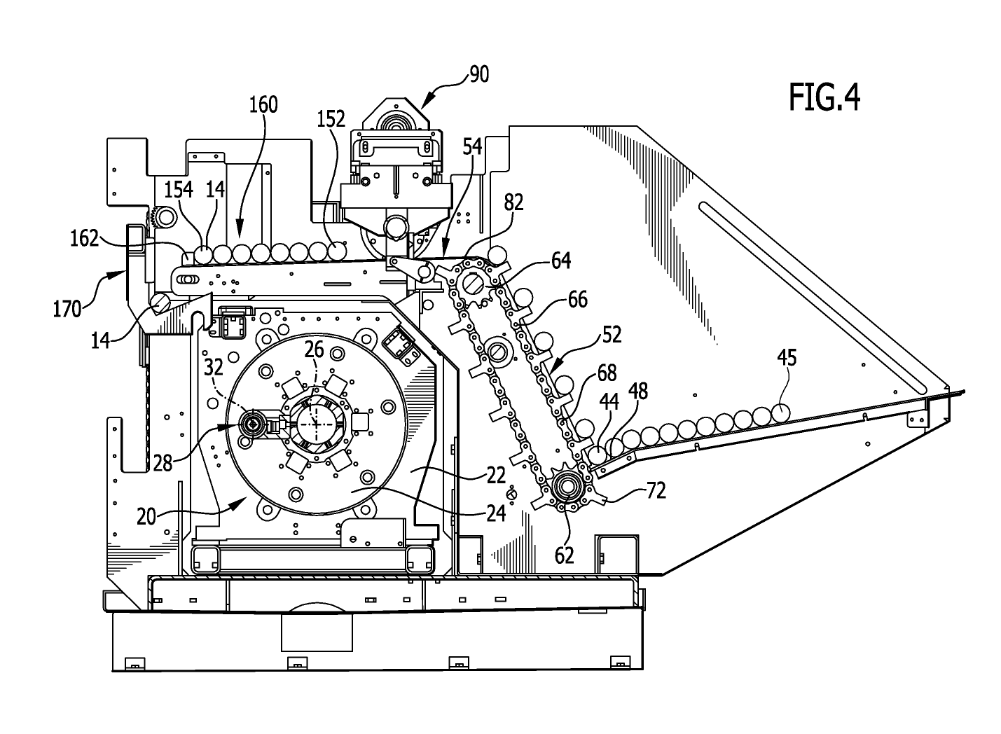

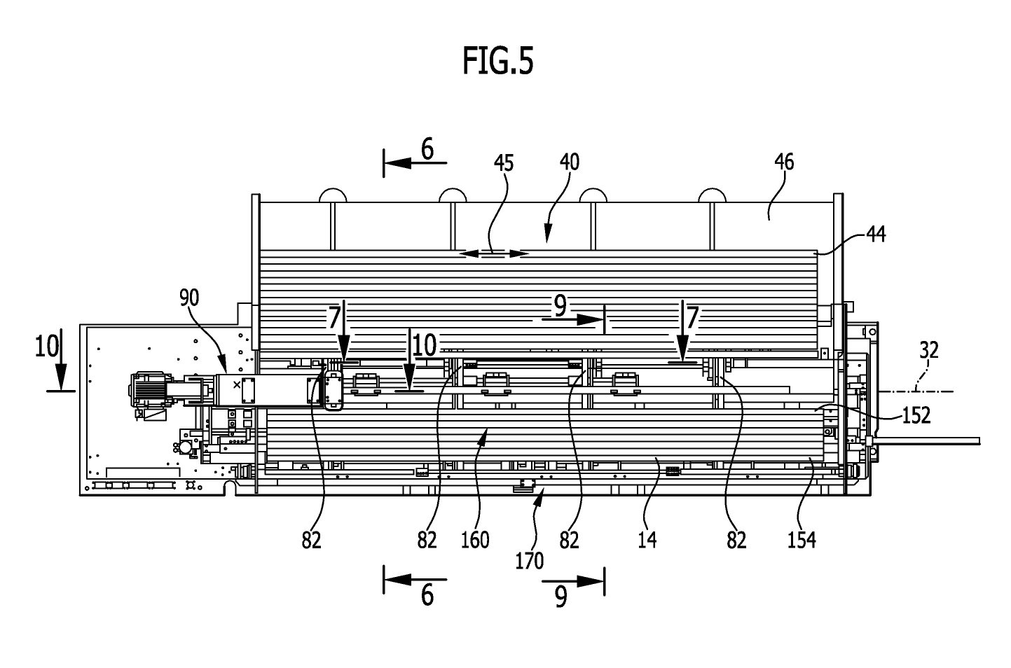

In the case of the first exemplary embodiment, the planar storage unit 42 of the bar stock loading unit 40 is provided with a loading platform 46 on which the blank items of bar stock 44 are depositable, wherein the loading platform 46 in relation to a horizontal is inclined in the direction of a bar transfer arrangement 48 in which, as is illustrated in FIG. 4, receiving of a blank item of bar stock 44 that is disposed in the bar transfer arrangement 48 is performed by a conveyor unit 52 which is configured as a chain conveyor, for example, and lifts the blank items of bar stock 44 from the bar transfer arrangement 48 and by lifting said blank items of bar stock 44 counter to the direction of gravity conveys them up to a transverse conveyor unit 54 which in the vertical direction is disposed above the bar magazine 20, in particular above the magazine frame 22 of the bar magazine 20.

The conveyor unit 52 that is configured as a chain conveyor, for example, comprises conveyor chains 66 which by way of a lower chain sprocket 62 and of an upper chain sprocket 64, which both are rotatably mounted on a basic frame 56, run in the manner of a closed loop and are disposed so as to be mutually parallel and are in particular sequentially spaced apart from one another in the direction parallel with the magazine axis 26, the chain run 68 of said conveyor chains 66 extending from the bar transfer arrangement 48 up to the transverse conveyor unit 54 receiving the blank items of bar stock 44 in the region of the bar transfer arrangement 48 by way of conveyor fingers 72 and transporting said blank items of bar stock 44 to the transverse conveyor unit 54, wherein the alignment of the items of bar stock 44 that is parallel with the magazine axis 26 is maintained, in particular.

Herein, the chain run 68 extends, in an inclined manner relative to a vertical, proceeding from the bar transfer arrangement 48 up to the transverse conveyor unit 54 with conveyor fingers 72 having an upwardly directed component in the vertical direction.

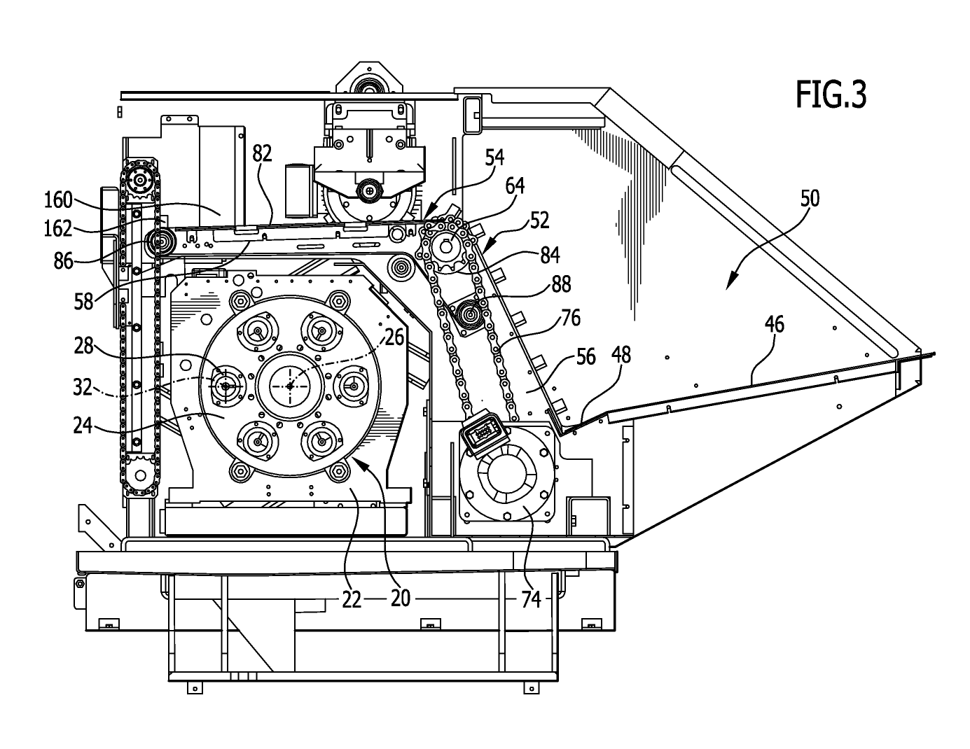

As is illustrated in FIG. 3, the conveyor unit 52 is driven by a drive motor 74 that is held on the basic frame 56 and on its part drives the upper chain sprockets 64 by way of a drive chain 76, for example.

As is also illustrated in FIGS. 2 to 4, the transverse conveyor unit 54 comprises a plurality of conveyor belts 82 that run so as to be mutually parallel and are in particular sequentially spaced apart from one another in the direction parallel with the magazine axis 46 and run by way of a first guide roller 84 that faces the conveyor unit 52 and by way of a second guide roller 86 that is disposed to said first guide roller 84 so as to be spaced apart in the transverse direction, both guide rollers 84 and 86 being rotatably mounted on a basic frame 58, said conveyor belts 82 being driven by a drive motor 88 that is held on the basic frame 56 and thus moving the items of bar stock 44 that lie on said conveyor belts 82 away from the conveying unit 52.

To this end, moving the blank items of bar stock 44 that have been transferred from the conveyor unit 52 to a machining unit for the blank items of bar stock 44 is performed first, said machining unit in its entirety being identified by the reference sign 90.

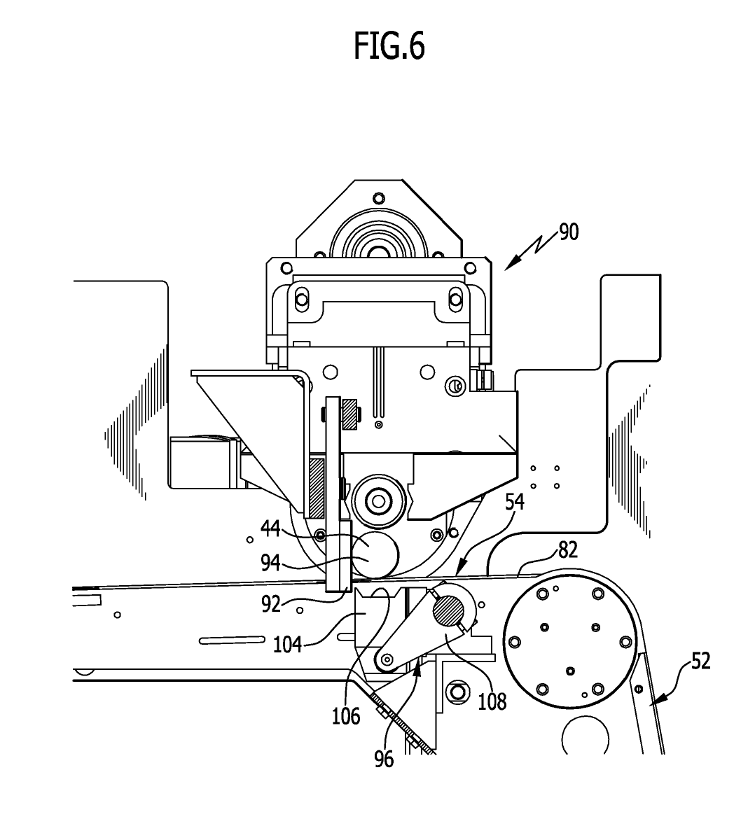

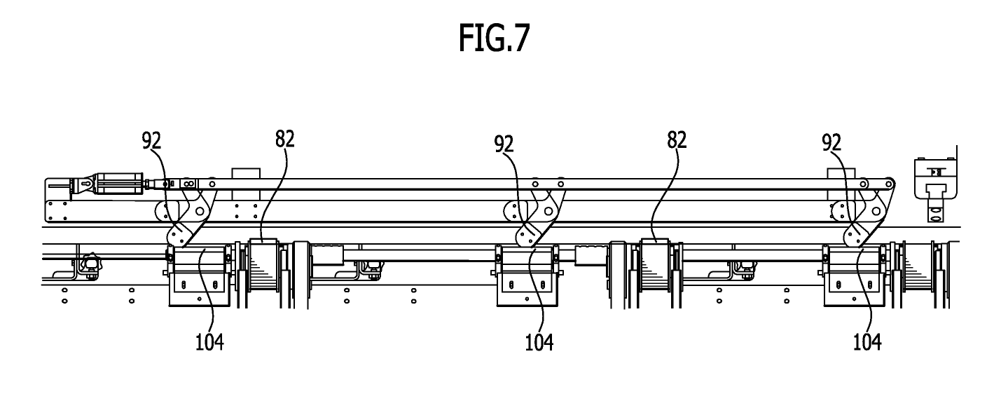

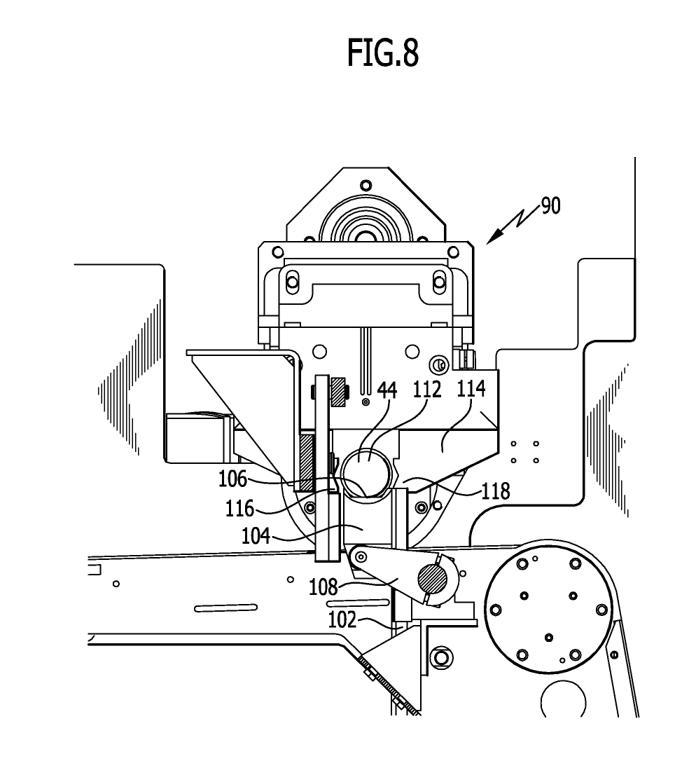

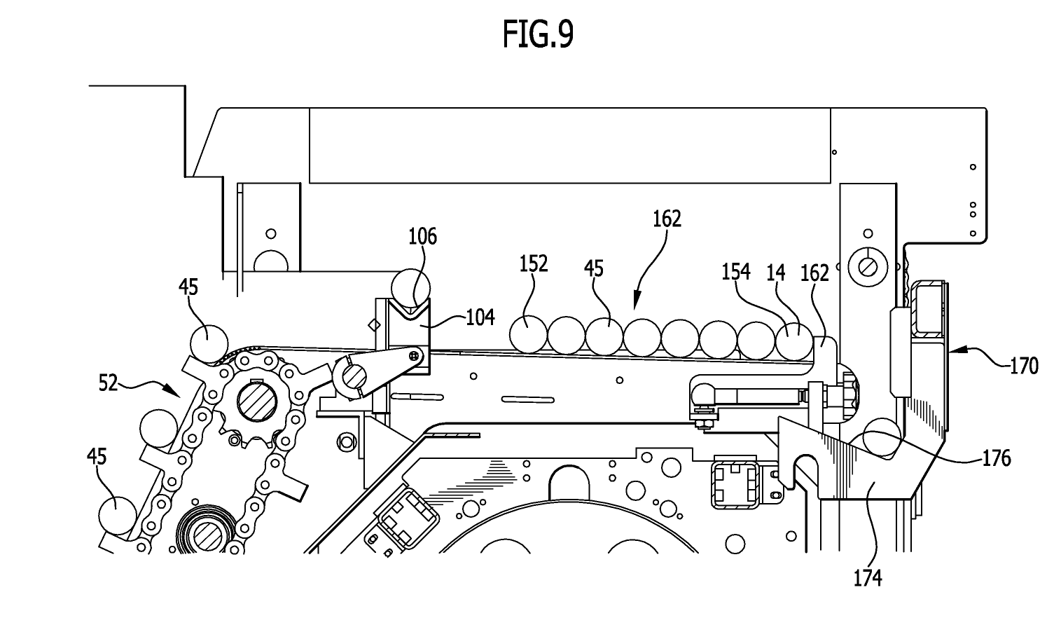

As is illustrated in detail in FIGS. 6 to 12, the machining unit 90 comprises detent elements 92 that can be lowered in the direction of the conveyor belts 82 and serve for stopping a blank item of bar stock 44 that comes from the conveyor unit 52 and is acquired by the transverse conveyor unit 54 in a transfer position 94 that in particular runs parallel with the magazine axis 26, such that receiving of this blank item of bar stock 44 can be performed by a lifting installation 96 which has, for example, lifting heads 104, guided on a lifting guide 102, having bar receptacles 106 which in an initial position are disposed below the conveyor belts 82 and by a lifting drive 108 are moved such that the lifting heads 104 together with the bar receptacles 106 move upward in the vertical direction, therein by way of the bar receptacles 106 acquire the blank item of bar stock 44 that lies in the transfer position 94 and lift said blank item of bar stock 44 relative to the conveyor belts 82 and over the latter, specifically to a machining position 112 in which the item of bar stock is aligned so as to be parallel with the magazine axis 26, in particular.

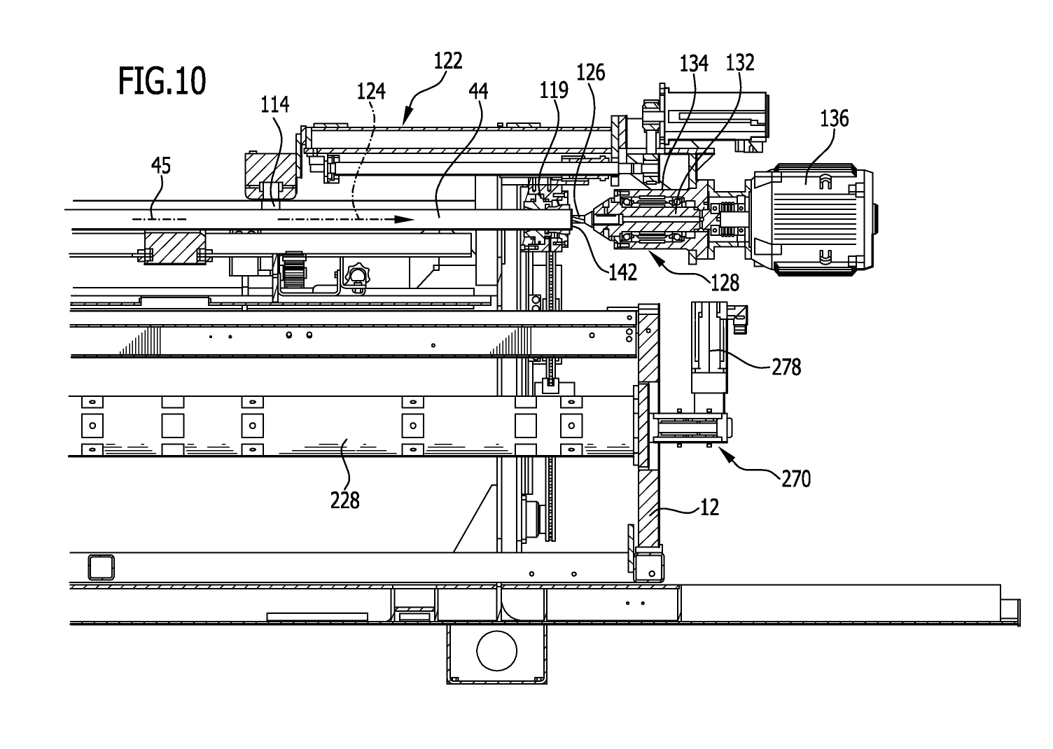

Gripping of the blank item of bar stock 44 is performed in the machining position 112 by a gripper unit 114 which, for example, has gripping jaws 116 and 118 that are disposed on opposite sides of the blank item of bar stock 44 that is in the machining position 112 and by way of which gripping jaws 116 and 118 the blank item of bar stock 44 is grippable and, as is illustrated in FIG. 10.

The item of bar stock 44 that is fixed in such a manner in relation to any displacement in the direction of the longitudinal axis 45 thereof is acquired by a clamping installation 119 that is configured as a collet chuck, for example, said clamping installation 119 being moved from the end that is to be machined over the item of bar stock 44 and acquiring the latter at a spacing from the end to be machined and positioning said item of bar stock 44 for machining. The clamping installation 119 is disposed on an advancing unit 122, and the clamping installation 119 and thus also the item of bar stock 44 in the case of a released gripper unit 114 are movable by means of this advancing unit 122 in the direction 124 that is parallel with the longitudinal direction 45 of said item of bar stock 44 and thus in particular in a manner parallel with the magazine axis 26, from a raised position onto a drilling tool 126 of a drilling unit 128 which in turn has a drilling spindle 132 that receives the drilling tool 126 and which is mounted in a spindle bearing of the drilling unit 128, said spindle bearing being disposed in a stationary manner, and said drilling spindle 132 being driven by a drive motor 136.

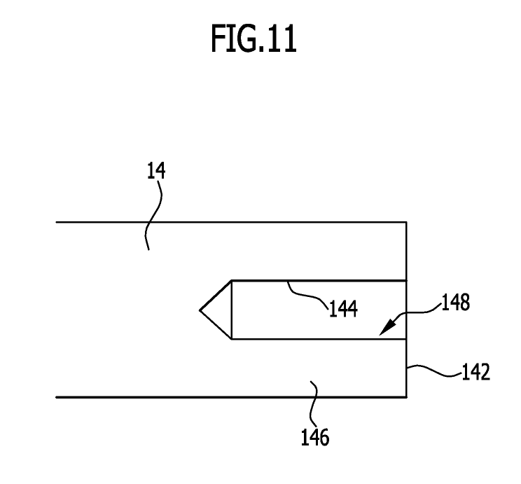

The blank item of bar stock 44 that is gripped by means of the clamping installation 119 can be moved by the advancing unit 122 so far toward the drilling unit 128 that a bore 144 that starts from a front end 142 of the blank item of bar stock 44 is incorporated into the item of bar stock 44 by way of the drilling tool 126, in order for an end contour 148 by way of which later acquiring or gripping of the premachined item of bar stock 14 that is provided with this end contour 148 is enabled to be generated at an end 146 of the item of bar stock that carries the front end 142, as will be described in detail hereunder (FIG. 11).

The end contour 148 in the context of the solution according to the invention is configured in an exemplarly manner in the form of a bore 144 (FIG. 11) that extends from the front end 142 into the item of bar stock 14; however, there is also the possibility for end contours 148 of other shapes which enable gripping of the item of bar stock 14 at the end 146 to be provided.

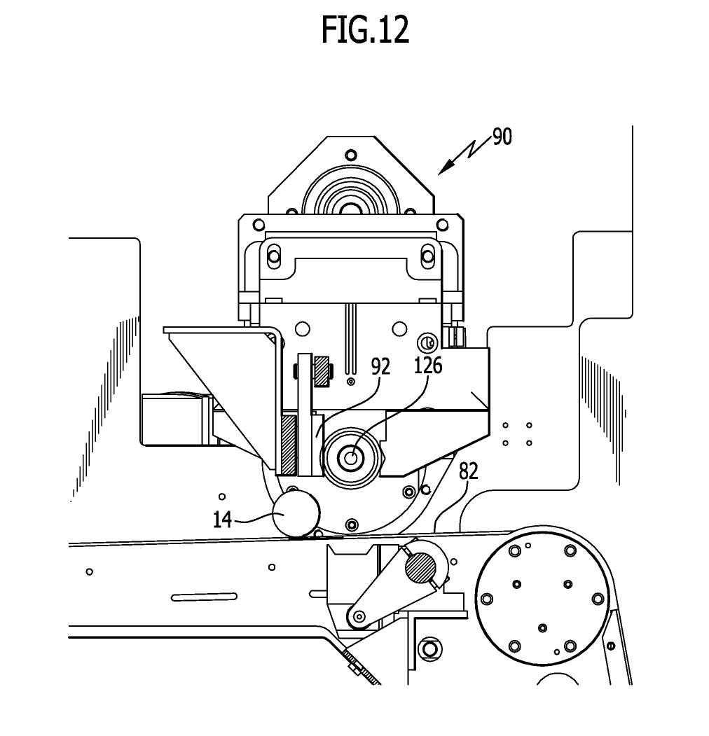

The item of bar stock 14 prepared in this manner is subsequently moved away from the drilling unit 128 again to the raised position, and by lowering by means of the lifting installation 96 is deposited on the conveyor belts 82 of the transverse conveyor unit 54, as is illustrated in FIG. 12, and in the case of inactive detent elements 92 that are disposed at a spacing from the conveyor belts 82 can be moved further away from the conveyor unit 52 by the conveyor belts 82 of the transverse conveyor unit 54.

The premachined items of bar stock 14 herein by way of the transverse conveyor unit 54 are movable to a receiving position 152 of a buffer storage unit which in its entirety is identified by the reference sign 160.

The buffer storage unit 160 herein, starting from the receiving position 152, extends up to a buffer detent 162 that establishes a discharging position 154 and, for example, is close to the guide roller 86 and thus on a side of the transverse conveyor unit 54 that is opposite the conveyor unit 52 and additionally at a spacing from the machining unit 90 such that, as is illustrated in FIGS. 2 and 4, for example, the premachined items of bar stock 14 in the buffer storage unit 160 are disposed so as to be beside one another and in particular aligned so as to be parallel with the magazine axis 26, wherein that premachined item of bar stock 14 that has been fed first to the buffer storage unit 160 abuts on the buffer detent 162, and the subsequently fed premachined items of bar stock 14 are disposed so as to be beside one another in the direction toward the machining unit 90.

The buffer storage unit 160 herein has an extent that is chosen in such a manner that at least so many premachined items of bar stock 14 as bar guides 28 are provided in the magazine drum 24 can be disposed beside one another between the receiving position 152 and the discharging position 154 and thus between the buffer detent 162 and the machining unit 90, such that when loading of premachined items of bar stock 14 into the bar guides 28 of the magazine drum 24 is to be performed, said items of bar stock 14 can all be acquired from the buffer storage unit 160.

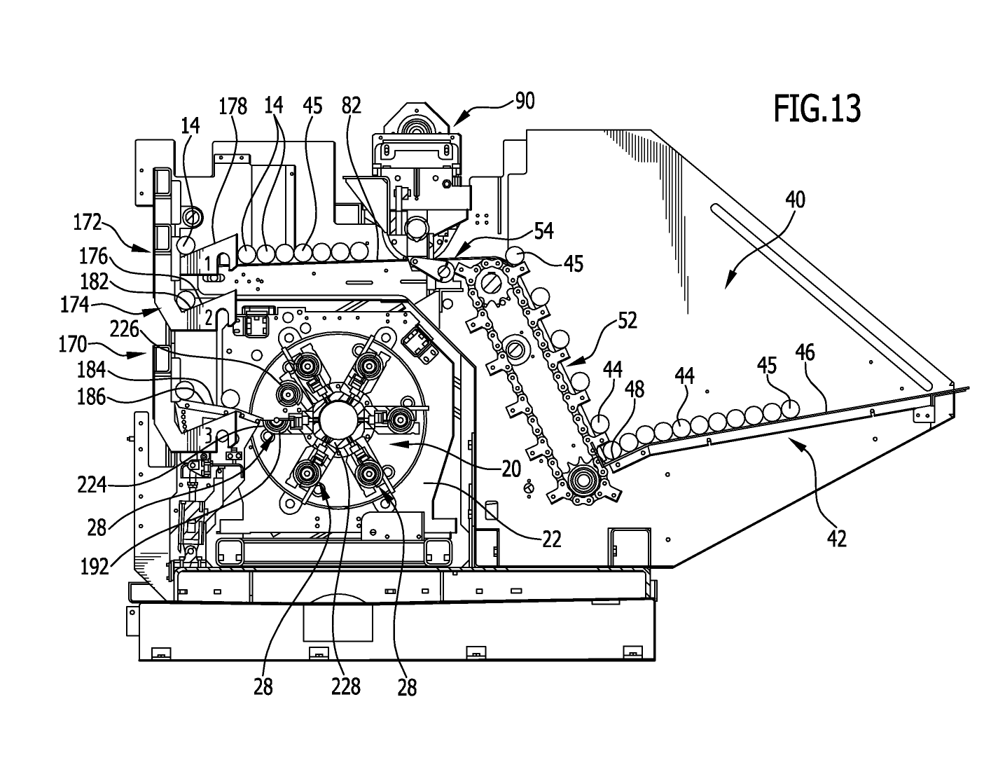

A loading unit 170, illustrated in FIG. 13, which comprises a lift conveyor 172 which is provided with lifting arms 174 that are movable in the vertical direction and have bar stock receptacles 176 and are raiseable in the vertical direction beyond the conveyor belts 82 (position 1 of the lifting arms 174 in FIG. 13) in order for the premachined items of bar stock 14 to be retrieved from the buffer storage unit 60 so as to lift that premachined item of bar stock 154 that in each case abuts directly on the buffer detent 162 is provided, wherein the bar stock receptacles 176 have oblique faces 178 which move the lifted premachined items of bar stock 14, driven by gravity, in the direction of a transportation position 182 in which the respective item of bar stock 14 is positioned in a collision-free manner in relation to the buffer storage unit 160 and to the buffer detent 162, such that in the case of a subsequent lowering of the lifting arms 174 (position 2 of the lifting arms 174 in FIG. 13) the premachined item of bar stock 14 is movable past the detent 162 and can be lowered that far until said premachined item of bar stock 14 comes to lie on an insertion device 184 (position 3 of the lifting arms 174 in FIG. 13) which is provided with an insertion ramp 186 such that the premachined item of bar stock 14 that is deposited on the insertion device 184 is movable, driven by gravity, by way of the insertion ramp 186 in the direction of a bar guide 28 that is in an insertion position 192.

As is illustrated in FIGS. 13, 14, and 15, each of the bar guides 28 comprises two guide segments 212 and 214 that are sequentially disposed in the direction of the respective guide axis 32 and are disposed so as to be mutually coaxial with the guide axis 32, wherein the guide segment 212 is disposed in a region on the magazine drum 24 that faces away from the lathe D, while the guide segment 214 is disposed in a region of the magazine drum 24 that faces the lathe D.

Furthermore, an intermediate removal space 216 is also provided between the guide segments 212 and 214, the function of said intermediate removal space yet to be explained in detail hereunder.

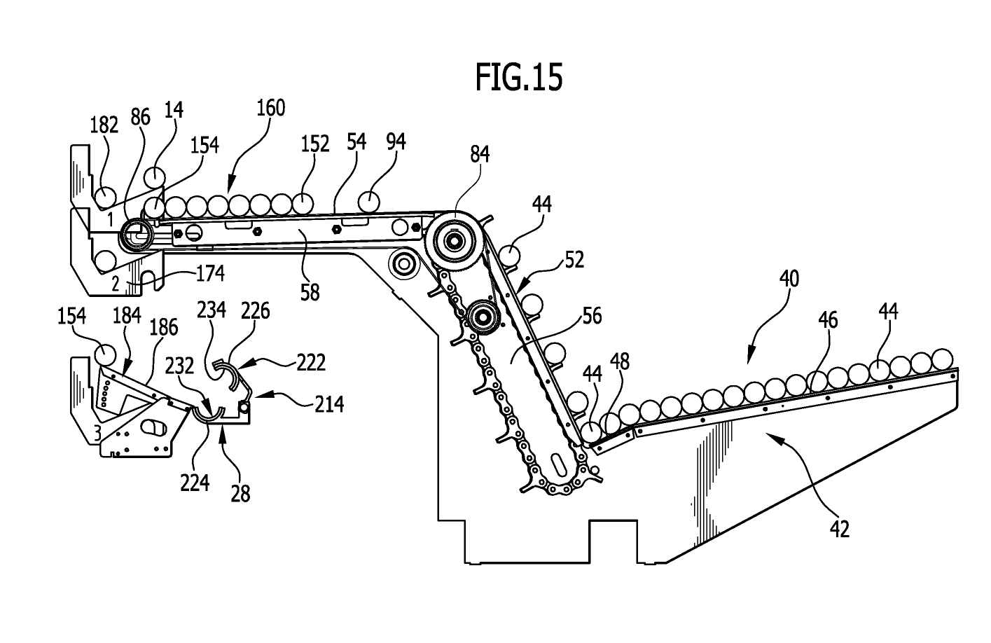

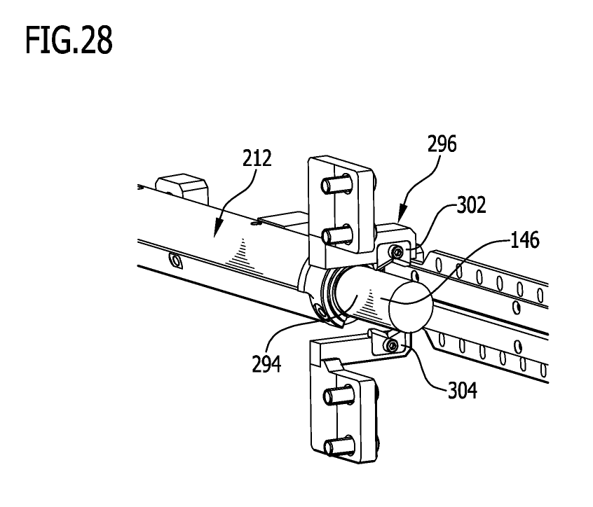

Each of the guide segments 212 and 214 has a guide housing 222 which comprises two guide housing shells 224 and 226, wherein, as is illustrated in particular also in FIG. 13, the respective guide housing shell 224 is fixedly held on a support body 228, in particular on a support body 228 that is configured as a tubular body, while the guide housing shell 226 is movable, in particular pivotable, relative to the guide housing shell 224 by way of a drive 227, such that a receptacle 232 that is formed by the guide housing shell 224, in particular configured as a half-shell like receptacle, is disposed such that the premachined item of bar stock 14, driven by gravity, by way of the insertion ramp 186 slides into the receptacle 232 of the guide housing shell 224, if it is in its insertion position, as is illustrated in FIGS. 13 and 15, and in addition enlarged in FIG. 28.

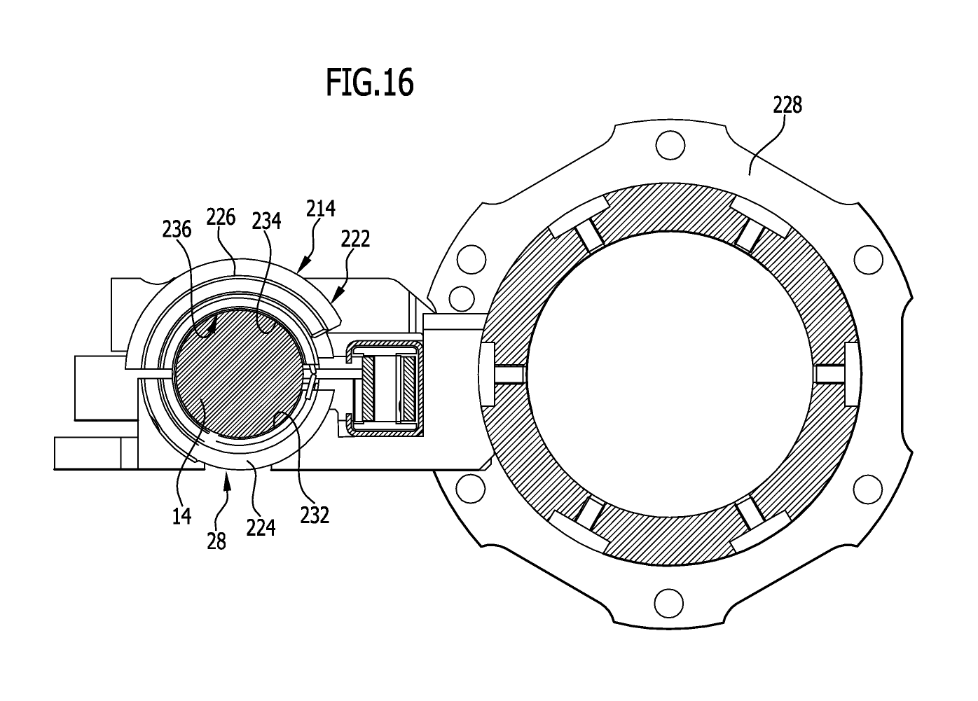

As is illustrated in FIGS. 15 and 16, the guide housing shell 226 in the case of the guide segment 214 is provided with a receptacle 234 that communicates with the receptacle 232 such that, upon insertion of the premachined item of bar stock 14, the guide housing 222 of the guide segment 214 can be closed in order for the premachined item of bar stock 14 to be reliably received in this guide segment 214 in a guide channel 236 that is formed by the receptacles 232 and 234.

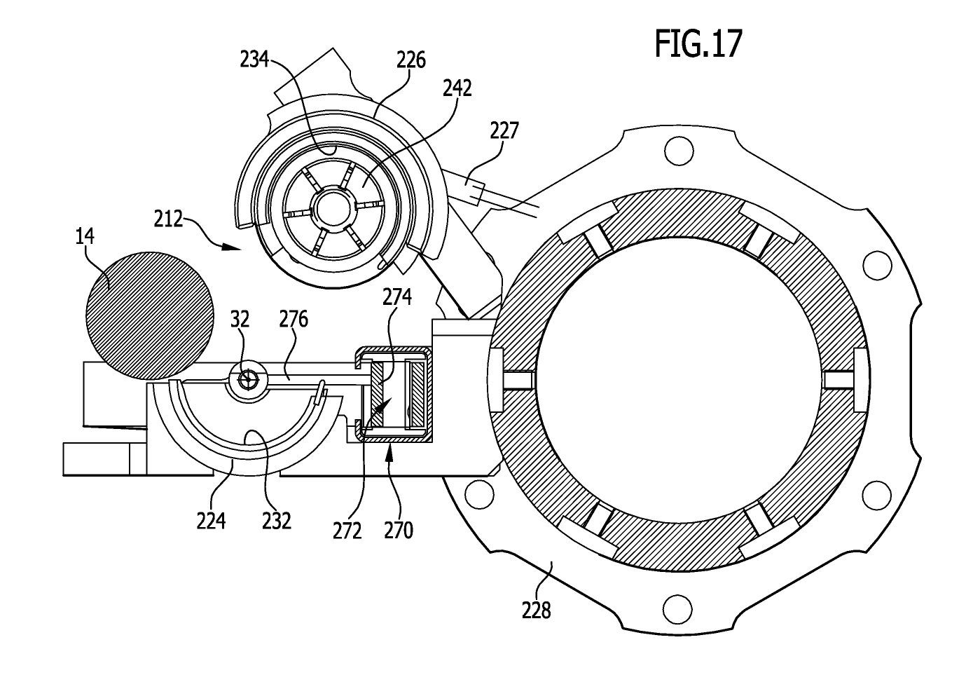

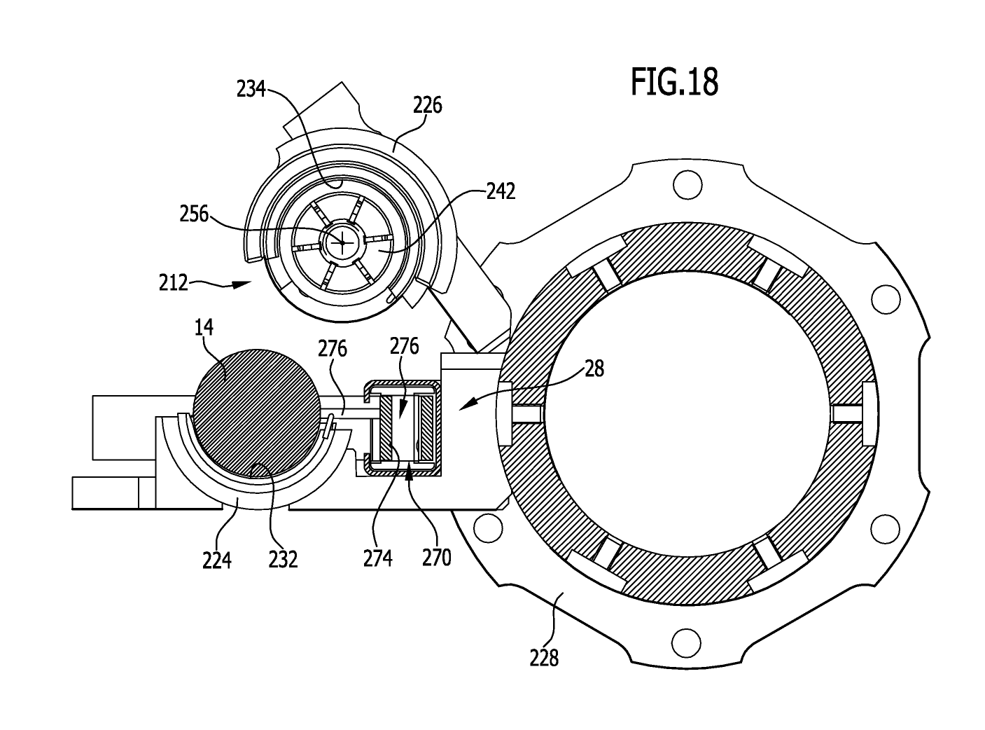

By contrast, as is illustrated in FIGS. 17 and 18 in the context of the guide segment 212, during the insertion of the premachined item of bar stock 14 a supply bar 242 is disposed in the receptacle 234 of the guide housing shell 226, said supply bar 242 by way of the guide housing shell 226 that is pivoted away from the guide housing shell 224 nevertheless permitting a collision-free insertion of the premachined item of bar stock 14 into the receptacle 232.

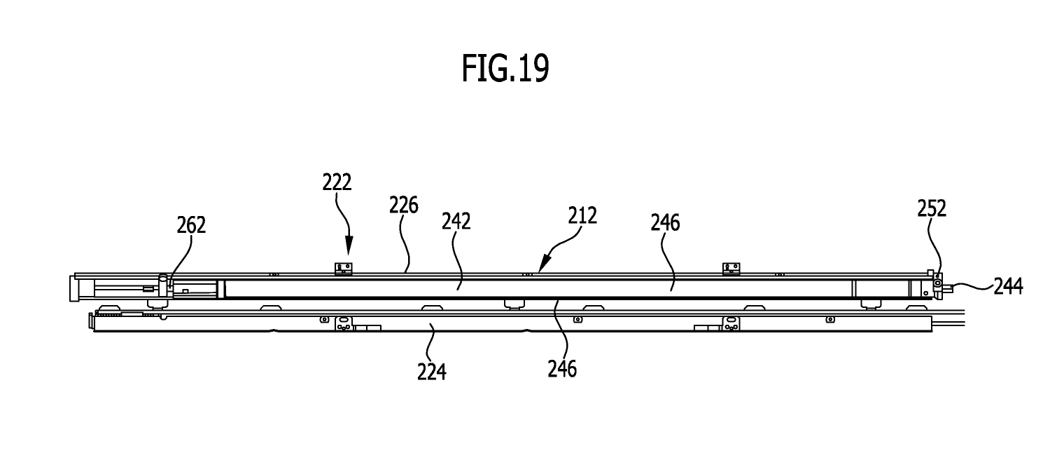

As is illustrated in FIG. 19, the supply bar 242 on that side thereof that faces the lathe D comprises a collet chuck 244 which is configured as an internal collet chuck, in particular, and serves for gripping the premachined item of bar stock 14 in the region of the end contour 148 thereof, wherein the collet chuck 244 in the case of being configured as an internal collet chuck engages in the bore 144 of the end contour 148.

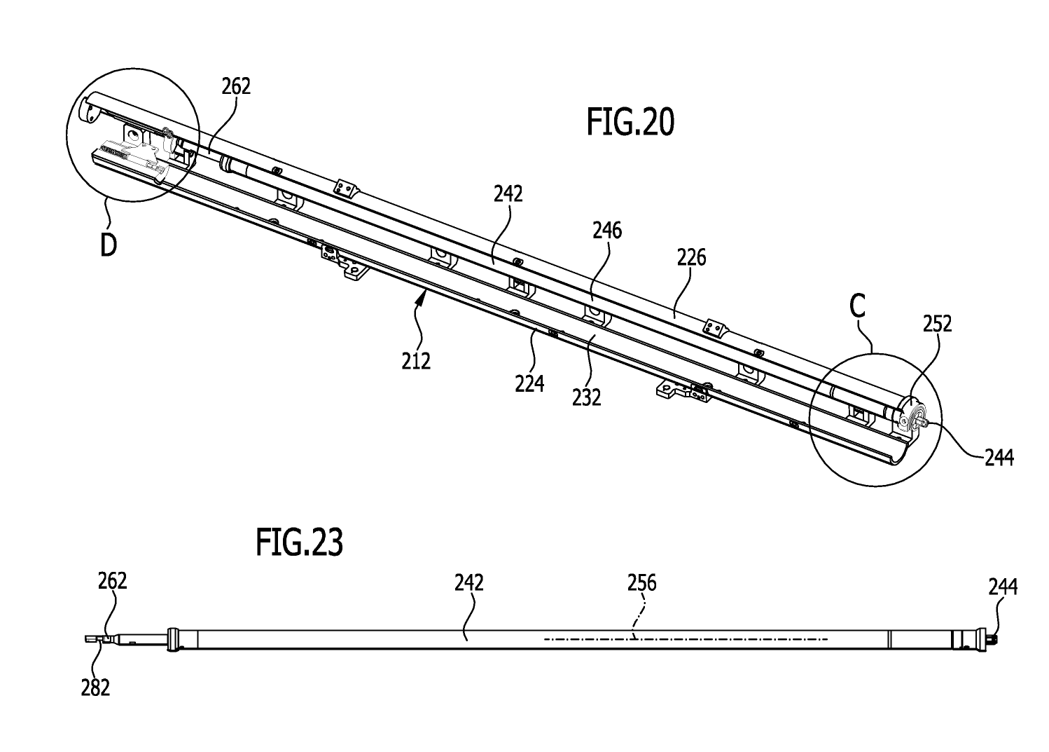

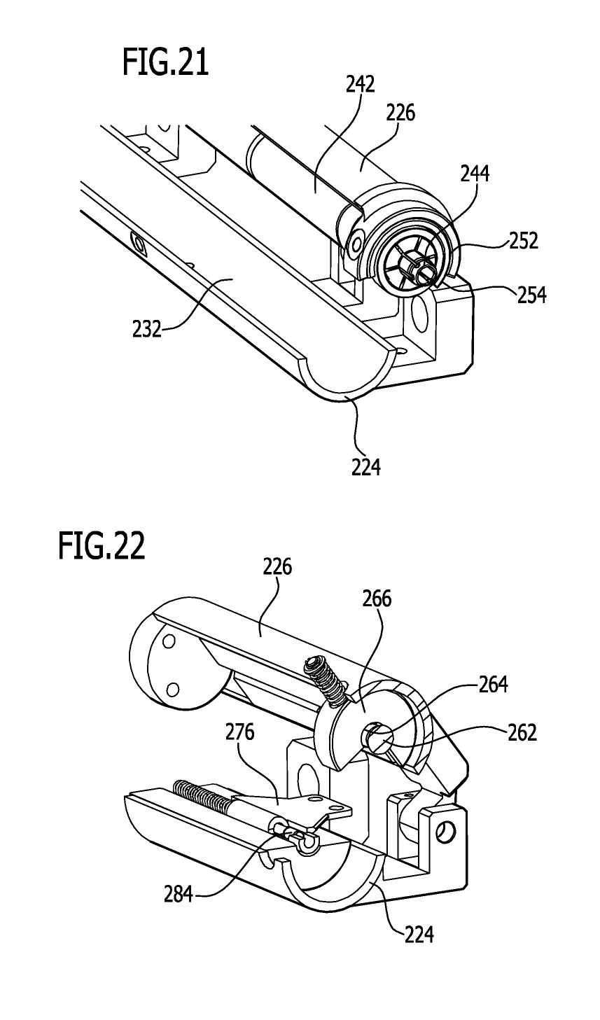

In the initial position 246 of maximum retraction of the supply bar 242, as is illustrated in FIGS. 19 to 21, said supply bar 242 is held in the guide segment 212 by way of a circumferential receptacle 252 which by way of a holding segment 254 embraces the supply bar 242 close to the collet chuck 244, said holding segment 254 comprising the supply bar 242 on the external circumference thereof by more than half the circumference, such that the supply bar 242, on account thereof, can be held in the guide housing shell 226.

Furthermore, as is illustrated in FIGS. 19 to 23, the supply bar 242 at that end thereof that is opposite the collet chuck 244, is provided with a holding journal 262 which in terms of the diameter thereof is reduced in relation to the supply bar 242 and which engages in a journal receptacle 264, in turn disposed in a journal receptacle body 266 that surrounds the holding journal 262 by more than half of an external circumference thereof and in turn is fixedly held in the guide housing shell 226.

The supply bar 242 thus remains in the initial position in the receptacle 234 of the guide housing shell 226 when the guide housing 222 of the guide segment 212 is opened and the guide housing shell 226 is thus pivoted away from the guide housing shell 224, and is pivoted conjointly with said guide housing shell 226, such that the receptacle 232 of the guide housing shell 224 is released for receiving an item of bar stock 14.

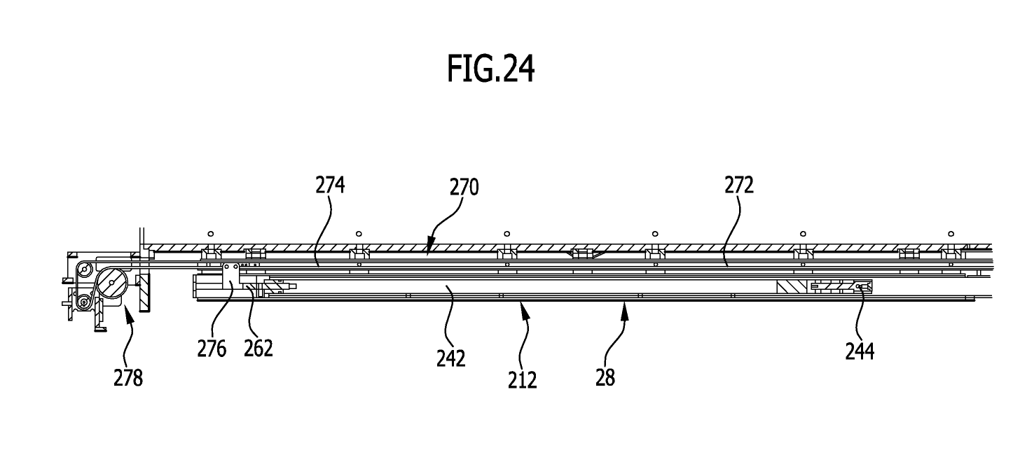

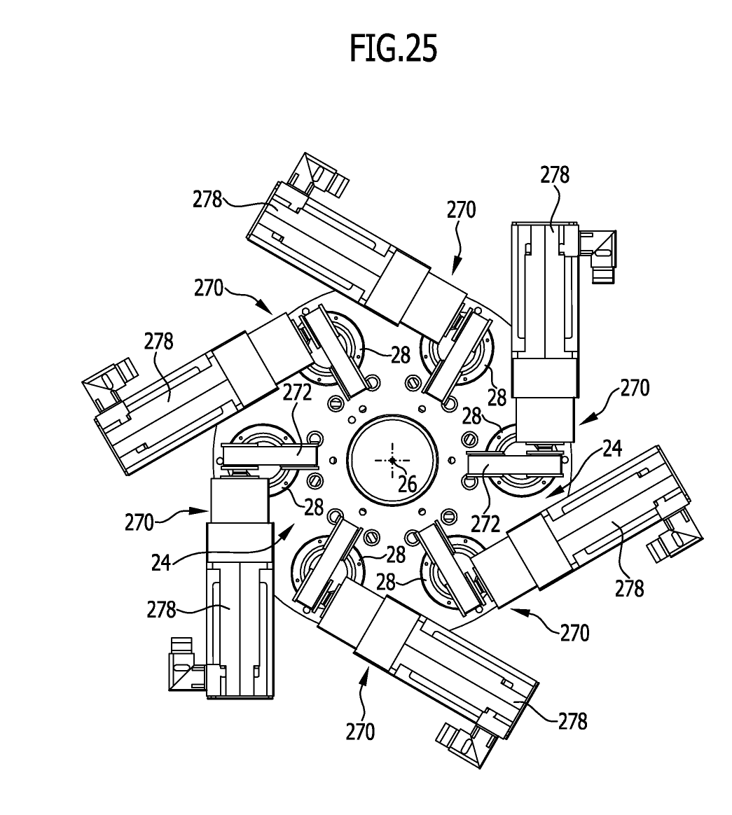

In order for the premachined item of bar stock 14, for example the premachined item of bar stock 14 that is already in the receptacle 232, to be displaced in the respective bar guide 28, an electronically controlled advancing unit which in its entirety is identified by the reference sign 270 is associated with each of the bar guides 28, as is illustrated in FIGS. 24 and 25, said advancing unit 270 having a drive belt 272 which extends along the bar guide 28 and thus along the guide segments 212 and 214, that run 274 of said drive belt 272 that is closest to the bar guide 28 being provided with an advancing finger 276.

The drive belt 272 herein by way of a drive unit 278 is drivable such that the advancing finger 276 which engages between the guide housing shells 224 and 226 also in the closed state of the latter, is movable along the guide segments 212 and 214, in particular across the entire length of the bar guide 28.

One electronically controlled advancing unit 270 of this type is permanently associated with each of the bar guides 28 such that each item of bar stock 14 in the respective bar guide 28 can be advanced and reversed in an individually electronically controlled and precisely positioned manner such that the advancing unit 270 for the item of bar stock in the respective bar guide 28 represents an electronically controlled and optionally even positionally regulated advancing axis.

In the case of a premachined item of bar stock 14 that is inserted into the receptacle 232 of the guide housing shell 224, and in the case of a still opened guide housing 222 of at least the guide segment 212, the item of bar stock 14 is now first advanced so far that the end contour 148 of the latter in the direction of the respective guide axis 32 is disposed so as to be spaced apart from the collet chuck 244 of the supply bar 242 that is held in the guide housing shell 226.

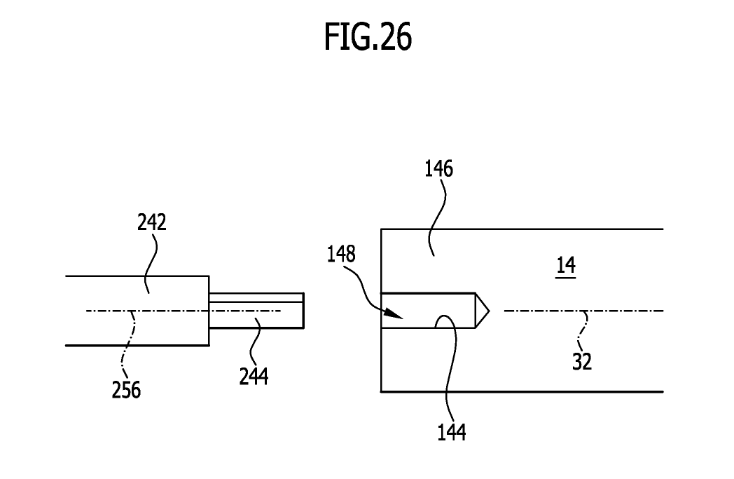

If the guide housing shell 226 is now moved toward the guide housing shell 224, and the guide housing 222 of the guide segment 212 is closed, the supply bar 242 on account thereof by way of the central axis 256 thereof is also thus positioned in the guide channel 236 so as to be coaxial with the guide axis 32. In this position, there is the possibility for connecting the supply bar 242 to the premachined item of bar stock 14 that has been pushed forward (FIG. 26), wherein the collet chuck 244 grips the premachined item of bar stock 14 at the end contour 148 in particular in that the collet chuck 244 that is configured as an internal collet chuck engages in the bore 144 in the end 146 of the premachined item of bar stock 14 such that the collet chuck 144 forms a force-locking connection to the end contour 148 which permits the premachined item of bar stock 14 in the bar guide 28 in the direction of the guide axis 32 to either be advanced in the direction of the lathe D, or to be retracted in the direction of the guide axis 32 away from the lathe D.

A gripper 296 is provided in order for the item of bar stock 14 to be held when the collet chuck 244 engages with the end contour 148, the arrangement and embodiment of said gripper 296 yet to be described in detail hereunder.

The premachined item of bar stock 14 is acquired by way of the bar stock gripper 296 once the latter has been pivoted into the intermediate removal space 216, and is moved in the direction of the collet chuck 244 such that the latter engages in the end contour 148 and fixes the item of bar stock 14 in a force-locking manner.

The bar stock gripper 196 is subsequently pivoted out of the intermediate removal space again.

In order for the holding journal 262 of the supply bar 242 to be connected to the advancing finger 276, the holding journal 262 is provided with a positively-locking contour 282 which in the initial position of the supply bar 242 and of the advancing finger 276 is capable of being brought to engage with a communicating positively-locking contour 284 of the advancing finger 276 such that a positively-locking connection is established between the holding journal 262 and the advancing finger 274 in the case of a closed guide housing 222 of the guide segment 212 and thus in the case of a coaxial alignment of the supply bar 242 relative to the guide axis 32, said positively-locking connection permitting the supply bar 242 to be moved by way of the advancing finger 276 both in the forward direction, that is to say toward the lathe, as well as in the reverse direction, that is to say away from the lathe.

Advancing of the premachined item of bar stock 14 in the guide segments 212 and 214 of the respective bar guide 28 is usually performed until this item of bar stock 14 in the lathe D has been worked through due to workpieces that have been sequentially produced and severed from the item of bar stock 14 to the extent that a leftover piece 294 is still connected to the supply bar 242, said leftover piece 294 however no longer being fit for processing into a workpiece.

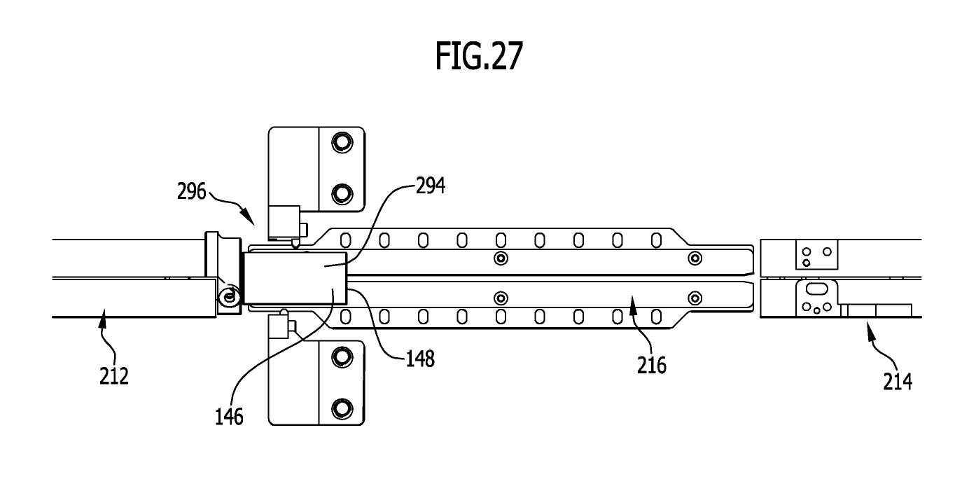

In this case, the leftover piece 294 by retracting the supply bar 242 to the initial position by means of the advancing drive 270 is moved out of the workpiece spindle into the bar guide 28 again, specifically through the guide segment 214 up to inside the intermediate removal space 216, as is illustrated in FIG. 27.

This leftover piece 294 of the item of bar stock 14 comprises the form-fit contour 148.

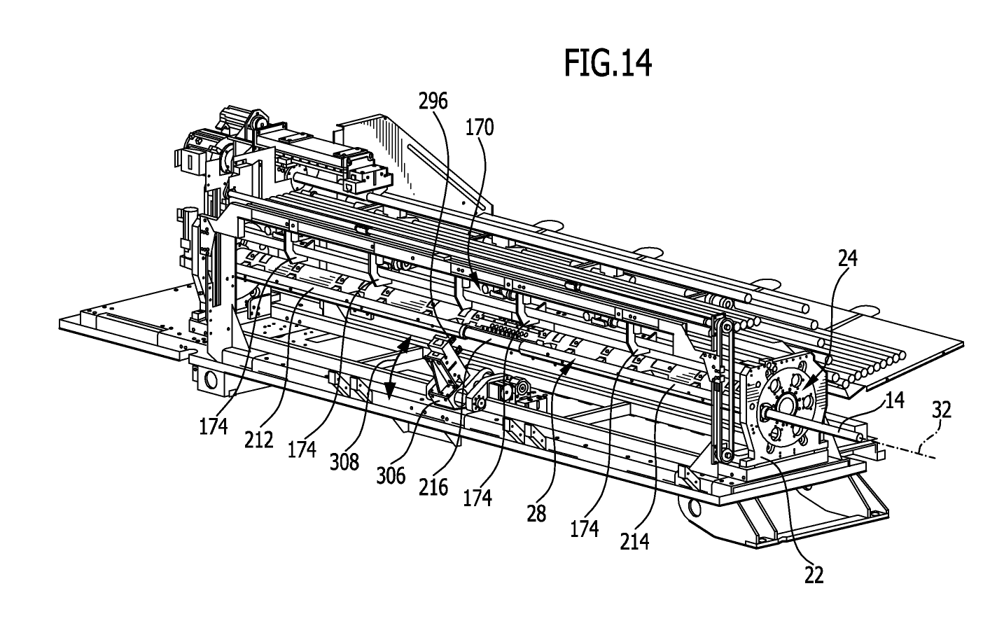

This leftover piece 294 that is still held by the supply bar 242 by way of the collet chuck 244, can be gripped in the intermediate removal space 216 between the guide segment 212 and the guide segment 214 by means of a bar stock gripper 296 (illustrated in FIG. 27 and FIG. 28) which by way of the gripping jaws 302 and 304 thereof is movable into the intermediate removal space 216, as is illustrated in FIG. 14.

The bar stock gripper 296 is preferably movable by means of a gripper movement unit 306, wherein the gripper movement unit 306 provides inward and outward pivoting of the bar stock gripper 296 in the direction 308, running transversely to the respective guide axis 32, and displacing of the bar stock gripper 296 parallel with the guide axis 32, so as to be able to still pull off the leftover piece 294 or, as has been already described above, to be able to push the item of bar stock 14 having the end contour 148 onto the collet chuck 244.

The leftover piece 294 after removal from the intermediate removal space 216 is moved by the bar stock gripper 296 to a disposal point.

The supply bar 242 is already moved to the initial position thereof in order for the leftover piece 294 to be removed by means of the bar stock gripper 296, such that upon removal of the leftover piece 294 the guide housing shell 226 can in turn be moved away from the guide housing shell 224 in the case of both guide segments 212 and 214 when the respective bar guide 28 is in the insertion position 192, wherein the supply bar 242 remains in the receptacle 234 of that guide housing shell 226 that has been moved away, and the receptacle 232 of the respective guide housing shell 224 of the guide segments 212 and 214 is thus freely available for inserting the next premachined item of bar stock 14.

The first exemplary embodiment of the bar feeding device 10 according to the invention is preferably provided with a controller 310 which controls loading of items of bar stock 14 into the bar guides 28 as follows.

The blank items of bar stock 44 that are in the bar stock loading unit 40 are fed by way of the conveyor unit 52 and of the transverse conveyor unit 54 to the machining unit 90.

An incoming blank item of bar stock 44 is stopped in the machining unit 90 by the detent elements 92 on the transverse conveyor unit 54, and then lifted by the lifting heads 104, wherein the lift drive 108 to this end is actuated by the control unit 310.

The lifted blank item of bar stock 44 is then gripped by the gripper unit 116 and then acquired by the clamping installation 119.

After the gripper unit 116 has been released, the clamping installation 119 together with the gripped blank item of bar stock 44 is moved by the advancing unit 122 in the direction of the drilling tool 126 of the drilling unit 128 such that the end contour 148 at the end 146 of the item of bar stock 44 is produced.

This now premachined item of bar stock 14, by moving the clamping installation 119 back to the raised position, fixing the item of bar stock 44 by way of the gripper unit 114, deploying the clamping installation 119 and thus releasing the premachined item of bar stock 14, and by subsequently lowering the lifting heads 104 while actuating the lifting installation 96 in a respective manner, is again deposited on the transverse conveyor unit 54 and moved by the transverse conveyor unit 54 in the buffer storage unit 160, specifically to the receiving position 152 thereof.

When premachined items of bar stock 14 are already provided in the buffer storage unit 160, the former are moved such that the item of bar stock 14 that has been inserted first into the buffer storage unit 160 reaches the discharging position 154 at the buffer detent 162.

The buffer storage unit 160 by continual feeding of items of bar stock 14 to the machining unit 90, by premachining these items of bar stock 44 in order for the end contour 148 to be produced, and by discharging the premachined items of bar stock 14 to the buffer storage unit 160 can thus be stocked independently for a loading procedure of the bar guides 28.

The size of the buffer storage unit 160 herein is chosen such that the number of the items of bar stock 14 that is stored in said buffer storage unit 160 preferably corresponds to at least the number of the bar guides 28 of the magazine drum 24 such that a sufficient number of premachined items of bar stock 14 is available when loading of the magazine drums 24 has to be performed because the items of bar stock 14 therein have been fully processed.

In the case of the fully processed items of bar stock 14 in the bar guides 28 of the magazine drum 24, the leftover piece 294 is in each case still in the workpiece spindle W of the lathe D.

For this reason, prior to loading of one of the premachined items of bar stock 14 into the respective bar guide 28, the supply bar 242 having the leftover piece 294 in this bar guide 28 is again retracted into the bar guide 28, specifically so far that said leftover piece 294 is in the intermediate removal space 216 between the guide segments 212 and 214 of the respective bar guide 28.

In this position, the leftover piece 294 can be released from the collet chuck 244 of the supply bar 242 by means of the bar stock gripper 296 and be disposed of.

By retracting the advancing finger 276 together with the supply bar 242, both the advancing finger 276 as well as the supply bar 242 are subsequently moved to the initial position thereof.

In this initial position, the supply bar 242 in the guide housing shell 226 is fixed in relation to a movement transverse to the guide axis 32 by way of the circumferential receptacle 252 of the holding segment 254 and the journal receptacle 264 of the journal receptacle body 266 in the movable guide housing shell 226.

The controller now actuates a drive 227 in order for the movable guide housing shell 226 to be opened such that the movable guide housing shell 226 is moved away from the guide housing shell 224, and the supply bar 242 that is fixed in the latter is removed from the receptacle 232 of the guide housing shell 224 and is only still held in the initial position by way of the guide housing shell 226.

A premachined item of bar stock 14 is insertable in this opened position of the guide housing 222 of the guide segments 212 and 214, wherein said insertion is performed by the loading unit 170 which in the discharging position 154 of the buffer storage unit 160 lifts the premachined item of bar stock 14 out of the buffer storage unit 160, lowers said item of bar stock 14, and thereby inserts the latter by way of a movement transverse to the guide axis 32 in an insertion position into the receptacle 232 of the guide housing shell 224, wherein in the insertion position the item of bar stock 14 in the advancing direction lies ahead of the advancing finger 276 which is in the initial position.

With the guide housings 222 still opened, advancing of the item of bar stock 14 by the advancing finger 276 in the respective bar guide 28 is performed so far that said item of bar stock 14 enters the workpiece spindle W and within the workpiece spindle W is preferably advanced up to a clamping installation.

Subsequently, returning of the advancing finger 276 to the initial position thereof by means of the control unit 310 is performed, and subsequently closing of the guide housings 222 is performed by moving the guide housing shells 226 onto the guide housing shells 224.

The supply bar 242 that is held in the guide housing shell 226 of the guide segment 212 is thus inserted between the advancing finger 276 and that end of the advanced item of bar stock 14 that is provided with the end contour 148, wherein closing of the guide housings 222 of the guide segments 212 and 214 is simultaneously performed.

By inserting the supply bar 242 into the receptacle 232 of the guide housing shell 224, in turn the positively-locking contours 282 and 284 between the advancing finger 276 and the holding journal 262 of the supply bar 242 are brought into engagement such that the supply bar 242 is thus coupled to the advancing finger 276 in such a manner that the supply bar 242 can be moved in the advancing direction and counter to the advancing direction by means of the advancing finger 276 that is drivable by the respective advancing drive 270.

By contrast, the collet chuck 244 in the initial position of the advancing finger 276 is still spaced apart from the end contour 248 and comes into engagement with the end contour 148 by slightly pushing back the item of bar stock 14 by means of the inwardly pivoted bar stock gripper 296, such that henceforth both the advancing finger 276 as well as the supply bar 242 and the item of bar stock 14 in the respective bar guide 28 are intercoupled in such a manner that said supply bar 242 and said item of bar stock 14 are advanceable by moving the advancing finger 276 in the direction of the lathe D, and are retractable again by moving the advancing finger in the opposite direction.

The item of bar stock 214 that is thus inserted into the bar guide 28 is henceforth ready for machining, wherein advancing of the item of bar stock 14 is performed by way of the respective electrically controlled advancing unit 270 that is associated with the bar guide 28 by means of the advancing finger 276 in a manner controlled by the control unit 310, so as to correspond to the machining cycles in the lathe.

After one of the items of bar stock 14 has been inserted into one of the bar guides 28, the magazine drum 24 is advanced such that the subsequent bar guide 28 is in the insertion position, and the same insertion procedure as has already been described follows, first by removing the leftover piece 294 and subsequently inserting the next item of bar stock 14 which henceforth is available in the discharging position 154 of the buffer storage unit 160.

In this way, all bar guides 28 are sequentially loaded with a premachined item of bar stock 14 until all bar guides 28 of the magazine drum 24 have been provided with a premachined item of bar stock.

By virtue of the fact that sufficient items of bar stock 14 for loading the bar guides 28 of the magazine drum 24 are available in the buffer storage unit 160, this loading is performed entirely independently of the premachining of the blank items of bar stock 44 in the machining unit 90.

In particular when the magazine drum 24 is completely loaded with premachined items of bar stock 14, and loading of these items of bar stock is performed, there is sufficient time available for refilling the buffer storage unit 160 with premachined items of bar stock 14 such that a sufficient number of premachined items of bar stock 14 is again available in the buffer storage unit 160 in the case of the next loading procedure of the bar guides of the magazine drum 24.

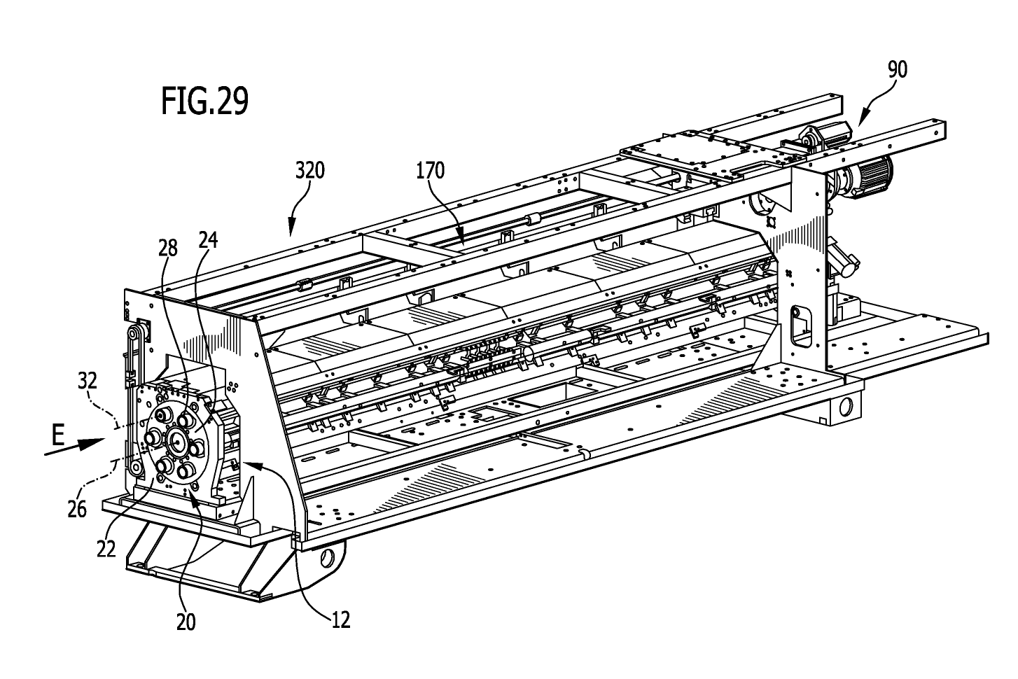

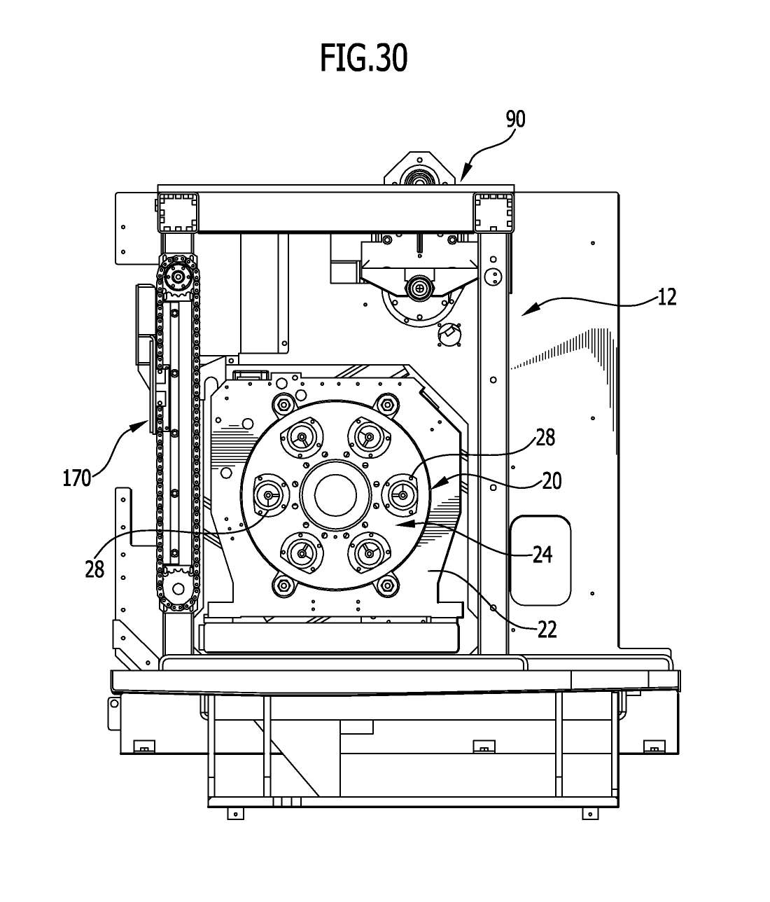

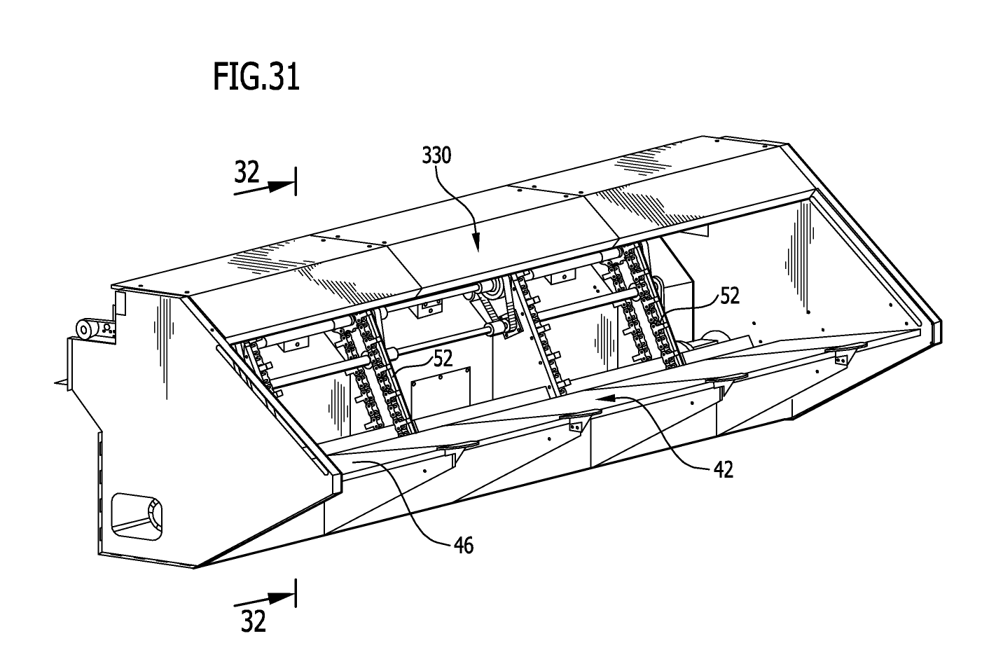

As is illustrated in FIGS. 29 to 31, the first exemplary embodiment of the bar feeding device 10 is configured such that the latter has a basic unit 320 which comprises the frame 12 having the bar magazine 20, and the machining unit 90 that is held on the frame 12, and the loading unit 170.

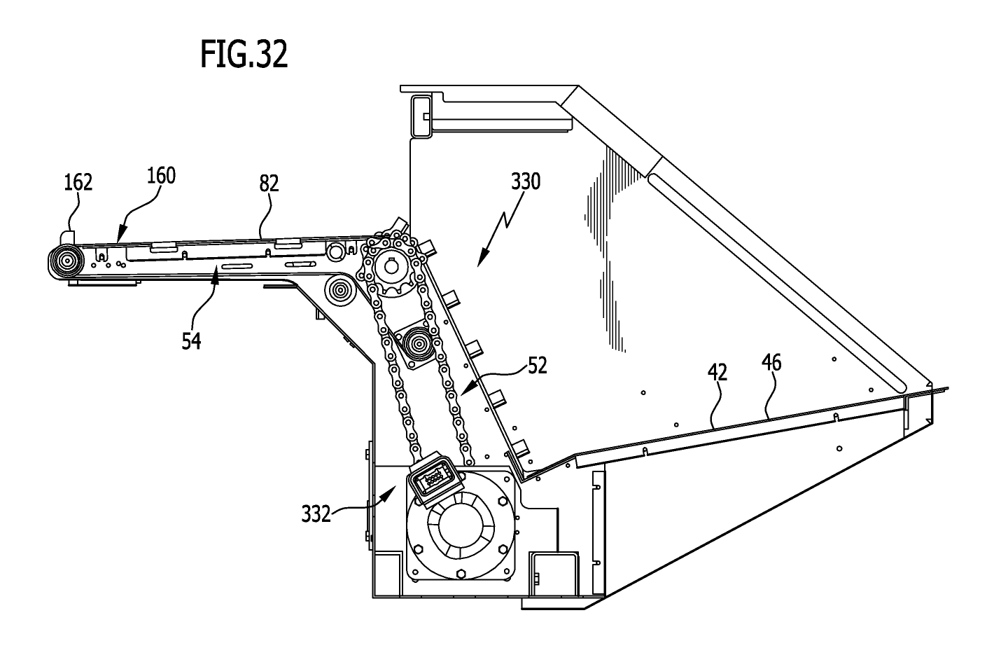

However, the basic unit 320 does not comprise the bar stock loading unit having the planar storage unit 42, said bar stock loading unit apart from the planar storage unit 42 comprising the conveyor unit 52 and the transverse conveyor unit 54, as is illustrated in particular in FIG. 32.

Both the conveyor unit 52 as well as the transverse conveyor unit 54 and the planar storage unit 42 are part of a planar loading unit which in its entirety is identified by the reference sign 330, said planar loading unit having a base frame 332 on which are arranged the planar storage unit 42, the conveyor unit 52 having the basic frame 56, the transverse conveyor unit 54 having the basic frame 58, and the buffer detent 162 for configuring the buffer storage unit 160 on the transverse conveyor unit 54.

The first exemplary embodiment of the bar feeding device 10 according to the invention can thus be produced in that the planar loading unit 330 having the base frame 332 is fitted to the frame 12 of the basic unit 320, such that on account thereof the bar feeding device 10 according to the invention according to the first exemplary embodiment having all aforementioned components is created.

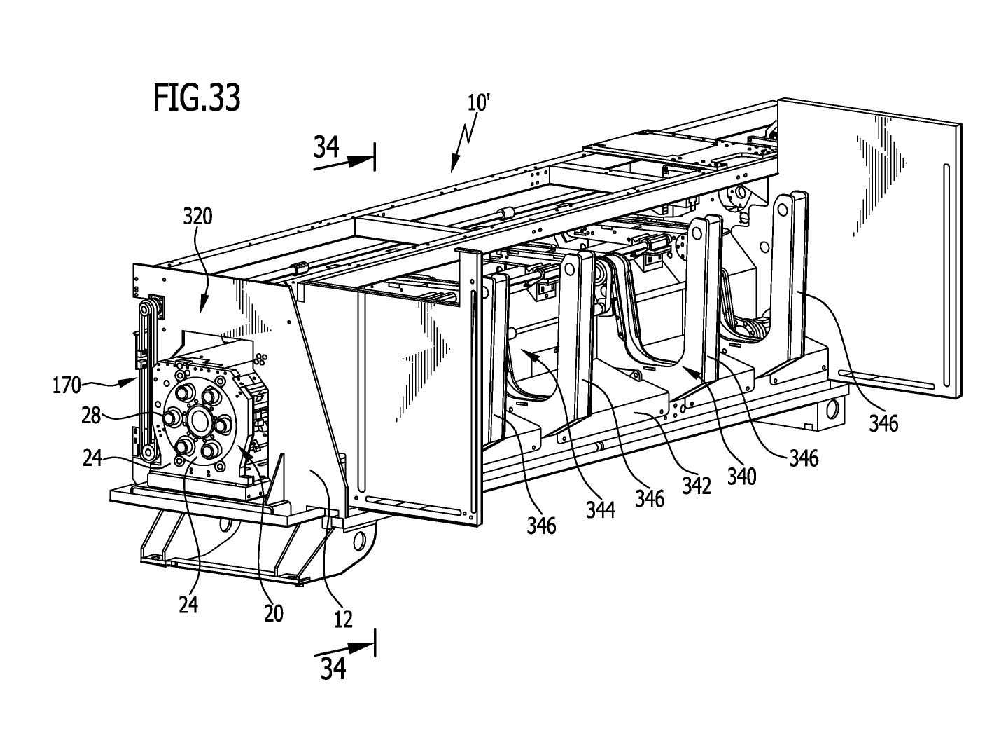

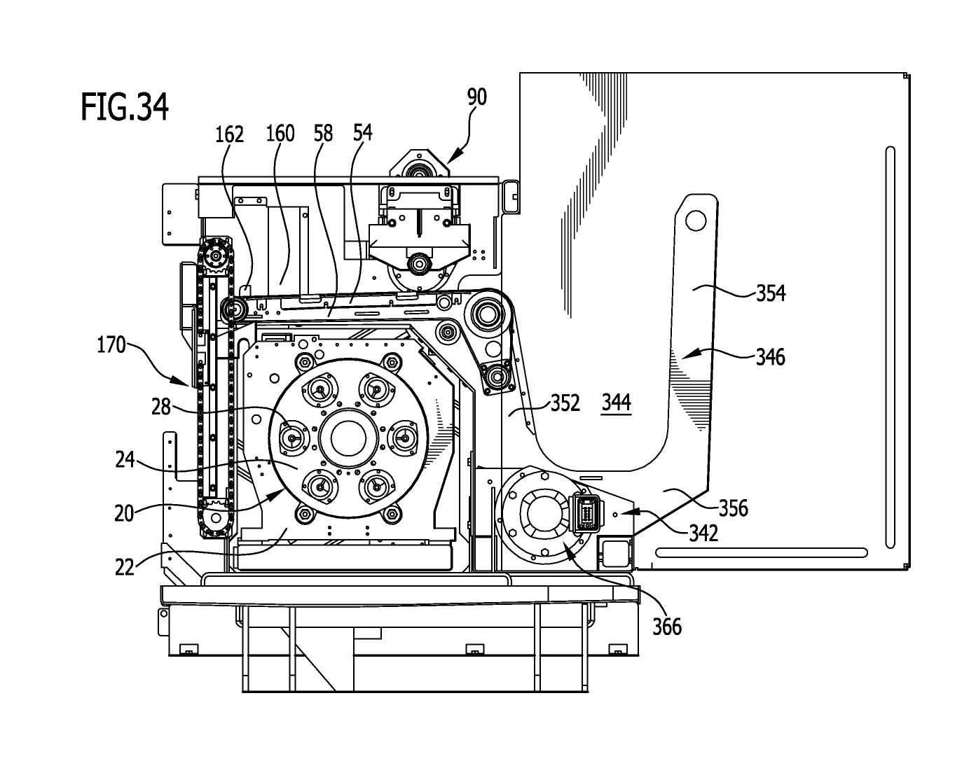

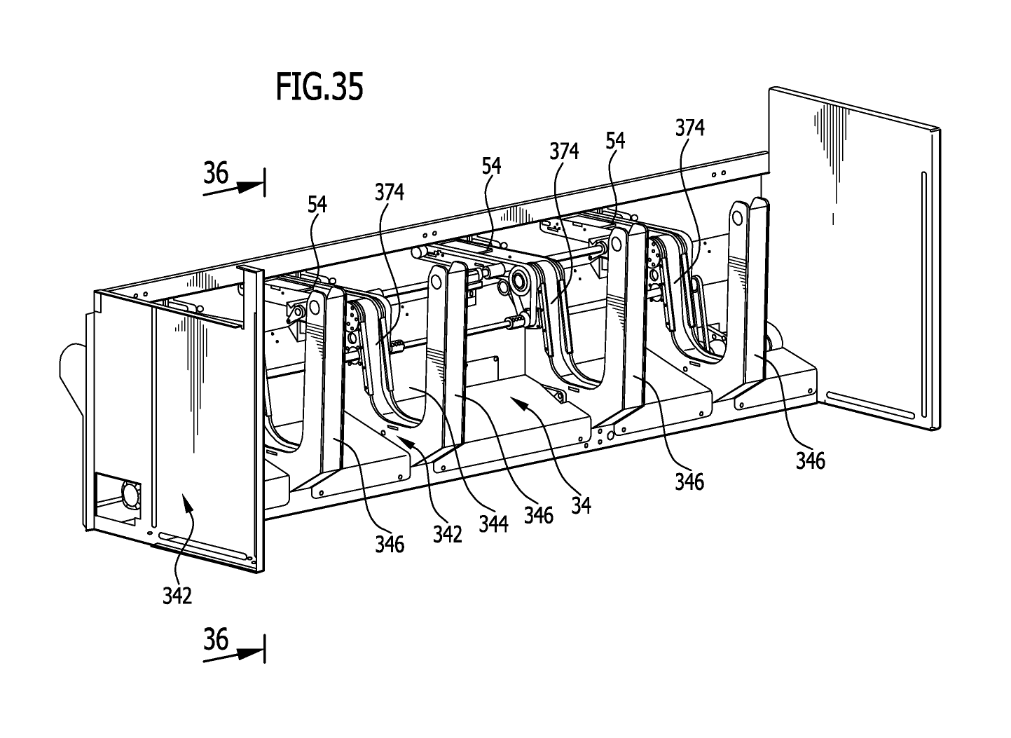

A second exemplary embodiment of a bar feeding device 10′ according to the invention, illustrated in FIGS. 33 to 37, likewise comprises the basic unit 320 that has already been described in the context of the first exemplary embodiment; however, no planar loading unit 330 is fitted to said basic unit 320, but a bundle loading unit which in its entirety is identified by the reference sign 340.

As is illustrated in FIGS. 33 to 37, a bundle loading unit 340 of this type comprises a base frame 342 on which holding elements 346 are disposed which define a bundle cradle 344 and which in the cross section are configured in a U-shape, for example, and have a lateral leg 352 which faces the transverse conveyor unit 54 for example, one lateral leg 354 which is opposite the lateral leg 352, and one central leg 356 which connects the lateral legs 352 and 354 in that region of the leg ends of the latter that in the direction of gravity is the lower region such that the construction of the bundle cradle 344 results above the central leg 356 and between the lateral legs 352 and 354.

The lateral leg 352 herein is connected in particular to the basic frame 58 of the transverse conveyor unit 54, the latter in this case being part of the base frame 342 of the bundle loading unit 340.

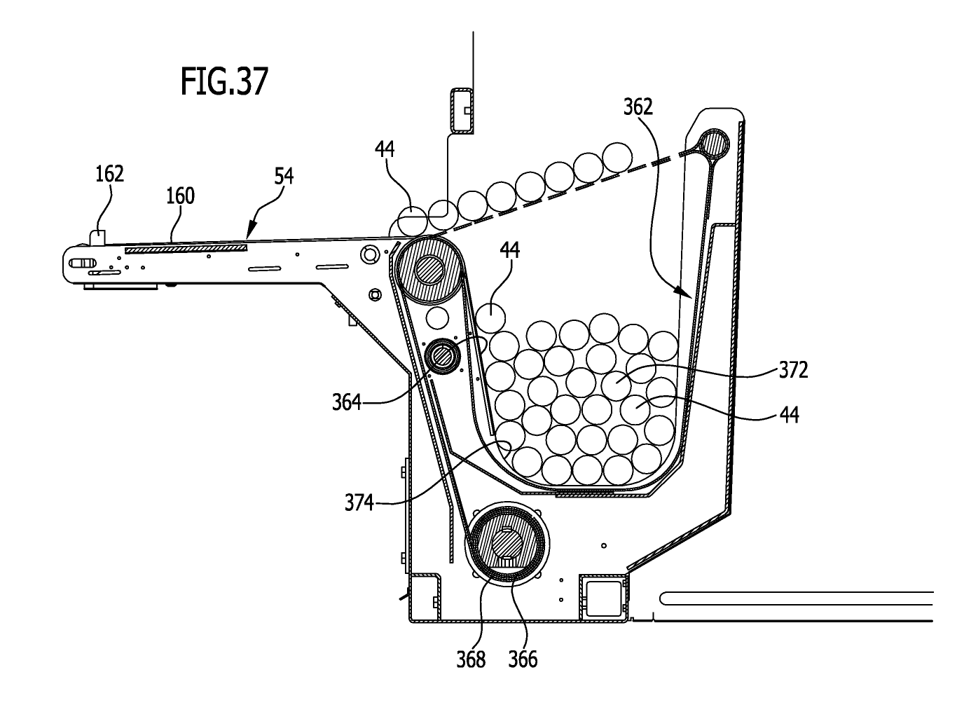

As is illustrated in FIG. 37, the bundle loading unit 340 furthermore comprises a bundle lifting system 362 which is formed, for example, by a plurality of lifting belts 364 that face the holding elements 346 and by way of a lifting belt drive 366 are capable of being wound onto a lifting belt drum 368, wherein the lifting belts 364 for loading the bundle loading unit 340 with a bundle 372 of blank items of bar stock 44 form a lifting belt sling 374 having a maximum extent that hangs into the bundle cradle 344 and abuts thereon preferably on the outside, in particular on the lateral legs 352 and 354 and on the central leg 356, in order for the entire bundle 372 of blank items of bar stock 44 to be received.

By progressive winding of the lifting belts 364 onto the lifting belt drum 368 by means of the lifting belt drive 366, there is now the possibility for the extent of the lifting belt sling 374 to be reduced and thus for the entire bundle 372 of blank items of bar stock 44 to be lifted, specifically to be lifted so far that a topmost blank item of bar stock 44, driven by gravity, moves onto the transverse conveyor unit 54 and is moved by the latter first to the machining unit 90 and then to the buffer storage unit 160.

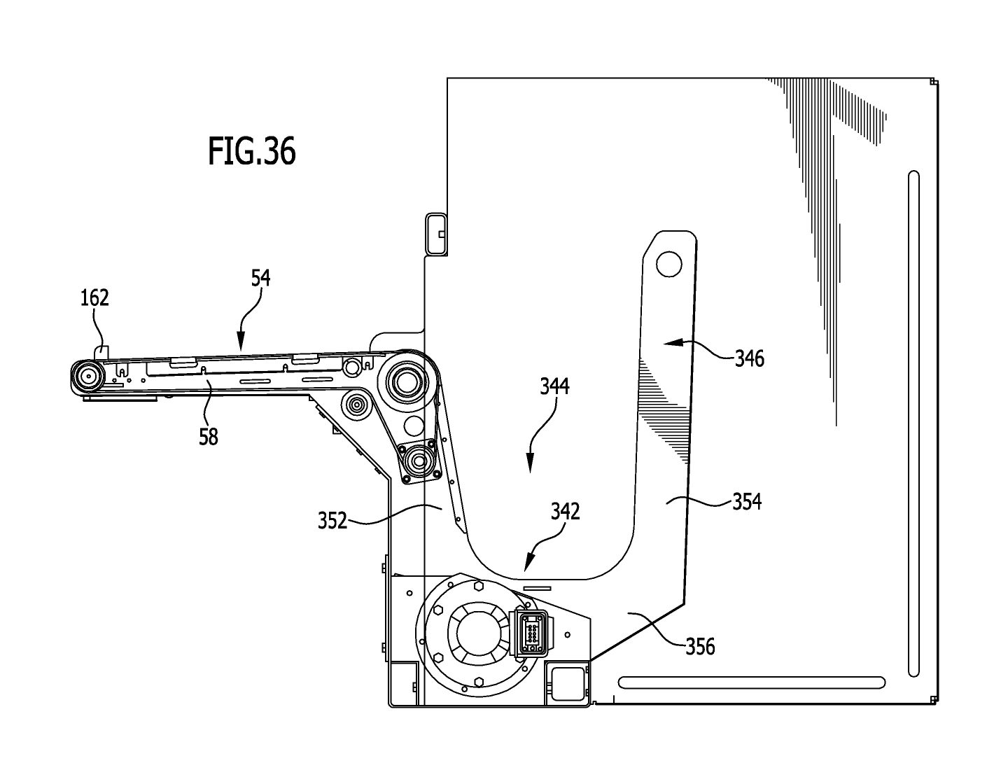

In an extreme case, the lifting belt sling 374 is reduced so far as illustrated with dashed lines in FIG. 36, that the lifting belt sling 374 is no longer existent, but forms a face that slopes down in the direction of the transverse conveyor unit 54 on which face the last blank items of bar stock 44 of the bundle 372 bear so as to move, driven by gravity, in the direction of the transverse conveyor unit 54.

Also in the case of the second exemplary embodiment, the bundle loading unit 340 in its entirety can be fitted to the basic unit 320, in particular by way of the base frame 342, on the frame 12 of the basic unit, in order for the bar feeding device 10′ according to the second exemplary embodiment, having all described components, to be obtained.

The advantage of the first and of the second exemplary embodiment, while using the same basic unit 320, lies in that the basic unit 320 can be produced therefrom independently, irrespectively of whether the latter is then used according to the first exemplary embodiment having a planar loading unit 330, or according to the second exemplary embodiment having a bundle loading unit 340, said loading units then being able to be selectively combined with the basic unit 320, without modifications to the basic unit 320 in terms of construction being required with a view to the use of a planar loading unit 330 or of a bundle loading unit 340.

To the extent that the second exemplary embodiment is identical to the first exemplary embodiment, in particular in terms of the construction of the identical basic unit 320, reference is made in terms of the configuration of the latter and the operation thereof to the complete content of the explanations pertaining to the first exemplary embodiment.

1. A bar feeding device comprising at least one bar guide for feeding at least one item of bar stock to at least one workpiece spindle of a lathe, and a machining unit, for producing an end contour at one end of the item of bar stock, which enables gripping of the end by means of a collet chuck in the bar guide, the bar feeding device has a bar loading magazine that is rotatable about a magazine axis and comprises more than two bar guides that are disposed about the magazine axis in a magazine drum, and in that the bar feeding device comprises a buffer storage unit that is disposed between the machining unit and the bar loading magazine and stores a plurality of premachined items of bar stock that are provided with the end contour.

2. The bar feeding device as claimed in claim 1, wherein the plurality of the premachined items of bar stock that are stored in the buffer storage unit correspond to at least the number of bar guides in the bar loading magazine, reduced by one item of bar stock.

3. The bar feeding device as claimed in claim 1, wherein the number of the items of bar stock that are stored in the buffer storage unit corresponds to the number of bar guides in the bar loading magazine.

4. The bar feeding device as claimed in claim 1, wherein the buffer storage unit is disposed in the vertical direction above the bar loading magazine.

5. The bar feeding device as claimed in claim 1, wherein the buffer storage unit has a storage element that carries the items of bar stock and in particular transfers the items of bar stock from a receiving position of the buffer storage unit to a discharging position of the buffer storage unit.

6. The bar feeding device as claimed in claim 1, wherein the buffer storage unit has a conveyor unit that moves the items of bar stock.

7. The bar feeding device as claimed in claim 1, wherein the buffer storage unit is adjoined by a loading unit which inserts the items of bar stock from the buffer storage unit into a receptacle of that bar guide that is in an insertion position.

8. The bar feeding device as claimed in claim 1, wherein the loading unit acquires the item of bar stock in the discharging position of the buffer storage unit and transports said item of bar stock to the receptacle of the respective bar guide that is in the insertion position.

9. The bar feeding device as claimed in claim 7, wherein the loading unit, by means of a lift conveyor, lowers the items of bar stock leaving the buffer storage unit.

10. The bar feeding device as claimed in claim 9, wherein the lift conveyor transfers the item of bar stock to an insertion device which introduces the item of bar stock into the receptacle of that bar guide that is in the insertion position.

11. The bar feeding device as claimed in claim 10, wherein the insertion device has an insertion ramp on which the item of bar stock, driven by gravity, moves into the receptacle.

12. The bar feeding device as claimed in claim 1, wherein a bar stock loading unit which stores blank items of bar stock and feeds the latter to the machining unit is disposed upstream of the machining unit.

13. A bar feeding device comprising at least one bar guide for feeding at least one item of bar stock to at least one workpiece spindle of a lathe, and a machining unit, for producing an end contour at one end of the item of bar stock, which enables gripping of the end by means of a collet chuck in the bar guide, the at least one bar guide and the machining unit form components of a basic unit which is combinable selectively with a bundle loading unit or a planar loading unit for storing and feeding items of bar stock to the basic unit.

14. The bar feeding device as claimed in claim 13, wherein the bundle loading unit and the planar loading unit each have one conveyor installation which conveys the item of bar stock to the machining unit.

15. The bar feeding device as claimed in claim 14, wherein the conveyor installation comprises a transverse conveyor unit which conveys the items of bar stock to the machining unit.

16. The bar feeding device as claimed in claim 13, wherein the planar loading unit has a planar storage unit having a loading platform on which the items of bar stock are stored.

17. The bar feeding device as claimed in claim 16, wherein the planar loading unit transfers the item of bar stock in a bar transfer arrangement to a conveyor unit which in turn transfers the item of bar stock to the transverse conveyor unit.

18. The bar feeding device as claimed in claim 13, wherein the bundle loading unit has a bundle cradle.

19. The bar feeding device as claimed in claim 18, wherein the bundle cradle is associated with a bundle lifting system which lifts a bundle of items of bar stock in the bundle cradle and feeds individual items of bar stock to the conveyor installation.

20. The bar feeding device as claimed in claim 19, wherein the bundle lifting system comprises lifting belts which receive the bundle by way of lifting belt slings that sag in the direction of gravity, and lift said bundle by reducing the size of the lifting slings.

21. A bar feeding device comprising at least one bar guide for feeding an item of bar stock to at least one workpiece spindle of a lathe, in particular a bar feeding device comprising at least one bar guide for feeding at least one item of bar stock to at least one workpiece spindle of a lathe, and a machining unit, for producing an end contour at one end of the item of bar stock, which enables gripping of the end by means of a collet chuck in the bar guide, said bar feeding device comprises a bar loading magazine that is rotatable about a magazine axis and has at least two bar guides that are disposed about the magazine axis on a magazine drum.

22. The bar feeding device as claimed in claim 21, wherein a guide axis of each of the bar guides runs parallel with the magazine axis.

23. The bar feeding device as claimed in claim 22, wherein the blank items of bar stock in the bar stock loading unit are disposed so as to be parallel with the guide axis of the bar guides.

24. The bar feeding device as claimed in claim 22, wherein the items of bar stock in the machining unit are machined at an alignment that is parallel with the guide axis of the bar guide.

25. The bar feeding device as claimed in claim 22, wherein the items of bar stock in the buffer storage unit are aligned so as to be parallel with the guide axis of the bar guides.

26. The bar feeding device as claimed in claim 22, wherein the items of bar stock are moved by the loading unit in an alignment that is parallel with the guide axes of the bar guides.

27. The bar feeding device as claimed in claim 22, wherein the items of bar stock on their way from the bar stock loading unit up to inside the bar guides are aligned so as to be parallel with the guide axis.

28. The bar feeding device as claimed in claim 22, wherein each of the bar guides is associated with a dedicated advancing unit for moving the item of bar stock in the direction of the guide axis.

29. The bar feeding device as claimed in claim 28, wherein the advancing unit is electronically controlled and positions the item of bar stock in a controlled manner in the direction of the guide axis.

30. The bar feeding device as claimed in claim 29, wherein the advancing unit positions the item of bar stock in a positionally regulated manner.

31. The bar feeding device as claimed in claim 28, wherein the advancing units of the bar guides are controlled in a mutually independent manner.

32. The bar feeding device as claimed in claim 28, wherein the advancing unit comprises an advancing element that engages in the respective guide channel of the bar guide.

33. The bar feeding device as claimed in claim 32, wherein an item of bar stock that is inserted into the bar guide is displaceable in the direction of the guide axis by way of the advancing element.

34. A bar feeding device, comprising at least one bar guide, comprising at least one bar guide for feeding an item of bar stock to at least one workpiece spindle of a lathe, in particular a bar feeding device comprising at least one bar guide for feeding at least one item of bar stock to at least one workpiece spindle of a lathe, and a machining unit, for producing an end contour at one end of the item of bar stock, which enables gripping of the end by means of a collet chuck in the bar guide, the at least one bar guide has at least one guide housing in which a guide channel for the item of bar stock runs.

35. The bar feeding device as claimed in claim 34, wherein the guide housing has two guide housing shells which for introducing the item of bar stock into the guide channel are configured to be moved apart from each other and towards each other transversely to the guide axis of the guide channel.

36. The bar feeding device as claimed in claim 35, wherein a second of the guide housing shells is configured to be movable apart from and towards the first of the guide housing shells.

37. The bar feeding device as claimed in claim 36, wherein the second of the guide housing shells is pivotable relative to the first of the guide housing shells.

38. The bar feeding device as claimed in claim 34, wherein a supply bar is insertable into a guide channel of the at least one bar guide.

39. The bar feeding device as claimed in claim 38, wherein the supply bar is coupleable to the advancing element.

40. The bar feeding device as claimed in claim 38, wherein the supply bar is held in an initial position in the movable guide housing shell, and said supply bar when said guide housing shell is moved from the closed position to the opened position is movable conjointly with said guide housing shell.

41. The bar feeding device as claimed in claim 40, wherein in the case of the second guide housing shell being in the opened position, the item of bar stock, in an insertion position that in the direction of the guide axis overlaps with the supply bar, is insertable into the receptacle of the first guide housing shell.

42. The bar feeding device as claimed in claim 38, wherein the in the item of bar stock by way of the advancing element is advanceable from the insertion position in the direction of the lathe.

43. The bar feeding device as claimed in claim 38, wherein the supply bar, in the case of an advancing element that is in an initial position and of an item of bar stock that is advanced in the direction of the lathe, is insertable between the advancing element and the item of bar stock.

44. The bar feeding device as claimed in claim 43, wherein the supply bar by moving the second guide housing shell from the opened position to the closed position is insertable between the advancing element and the advanced item of bar stock.

45. The bar feeding device as claimed in claim 38, wherein the supply bar when being inserted between the advancing element and the advanced item of bar stock is coupleable to the advancing element.

46. The bar feeding device as claimed in claim 38, wherein the supply bar is provided with a collet chuck.

47. The bar feeding device as claimed in claim 34, wherein the respective bar guide comprises two guide segments that are sequentially disposed in the direction of the guide axis, an intermediate removal space being disposed between said guide segments.

48. A method for operating a bar feeding device comprising at least one bar guide for feeding at least one item of bar stock to at least one workpiece spindle of a lathe, and a machining unit by way of which an end contour on each item of bar stock is produced by machining one end, the items of bar stock that are provided with the end contour are stored in a buffer storage unit and are sequentially loaded from the buffer storage unit into a plurality of bar guides.

49. The method as claimed in claim 48, wherein the bar guides are sequentially moved to an insertion position in which loading thereof with one of the items of bar stock from the buffer storage unit is performed.

50. The method as claimed in claim 48, wherein the bar guides for loading the items of bar stock are individually and sequentially moved to the same insertion position and loaded with items of bar stock.

51. The method as claimed in claim 48, wherein blank items of bar stock are fed to the machining unit, machined thereby and then transferred to the buffer storage unit.

52. The method as claimed in claim 48, wherein the bar guides have a guide housing of guide housing shells, said guide housing for in each case inserting the items of bar stock being opened by moving apart the guide housing shells.

53. The method as claimed in claim 48, wherein the respective item of bar stock is inserted into the respective bar guide transversely to a guide axis of the bar guides.

54. The method as claimed in claim 48, wherein the item of bar stock that in the insertion position is inserted into one of the guide housing shells is advanced in the direction of the lathe by way of an advancing element.

55. The method as claimed in claim 48, wherein the supply bar, in the case of an advancing element that is in an initial position, is inserted in an insertion position into one of the guide housing shells in the advancing direction ahead of the advancing element.

56. The method as claimed in claim 48, wherein upon the item of bar stock having been advanced by the advancing element, the advancing element is moved back to the initial position thereof, and the supply bar is then inserted between the advancing element and the advanced item of bar stock.

57. The method as claimed in claim 48, wherein the supply bar in the initial position thereof is held in one of the guide housing shells, and in that the item of bar stock when being inserted is inserted into a receptacle of the other of the guide housing shells.

58. The method as claimed in claim 57, wherein the item of bar stock that is inserted into the receptacle of the other guide housing shell in the case of moved apart guide housing shells is advanced in the direction of the lathe.

59. The method as claimed in claim 57, wherein the supply bar is inserted between the advancing element and the advanced item of bar stock by closing the guide housing shells.
